(19) United States
(12) Patent Application Publication
(10) Pub. No.: US 2016/0052798 A1
(43) Pub. Date: Feb. 25, 2016

(54) ENHANCED WATER TREATMENT SYSTEM

(71) Applicant: Aquion, Inc., Elk Grove Village, IL (US)

(72) Inventors: James J. Downs, Bloomingdale, IL (US); Andrew J. Kajpust, Hanover Park, IL (US)

(21) Appl. No.: 14/464,316

(22) Filed: Aug. 20, 2014

(51) Int. Cl. C02F 1/00

(52) U.S. Cl. CPC C02F 1/008; C02F 2209/006

(57) ABSTRACT

Liquid treatment systems (e.g., water treatment systems) with enhanced components and systems are disclosed. For example, the water treatment system may be enhanced by incorporating a location determination component and one or more measurement components (e.g., to measure temperature, flow, pH, composition, etc.). A data store of location information may be created comprising current and/or historical location of the water treatment system. Using transmission capabilities, the water treatment system may transmit collected data to a remote server for, inter alia, storage, aggregation, filtering, and/or analysis. Collectively, the aggregate data from a plurality of networked water treatment systems may form a repository of information that offers synergistic benefits that improve numerous aspects of water treatment systems and the related systems and users to which those water treatment systems provide service.

### TECHNICAL FIELD

Certain aspects of the disclosure relate to liquid treatment systems such as water softener systems, valve control systems, apparatuses, and methods using the aforementioned. In particular, certain aspects of the disclosure relate to liquid treatment systems and methods involving use of a location determination component and/or other measurement components to collect and aggregate data for display, analytics, and/or alert generation.

### BACKGROUND

Water softening systems are used to remove minerals such as calcium and magnesium ions from “hard” groundwater that has dissolved these minerals from the earth. These systems often utilize a resin tank containing a resin material, such as polystyrene beads, that is initially ionically bonded to sodium ions. When the hard water flows through the resin material, the “hard” calcium and magnesium ions replace the sodium and ionically bond to the resin material due to their relatively stronger ionic charge. Water softening systems require the periodic replenishing of sodium ions, typically though the use of a regeneration cycle where a brine solution having a high concentration of sodium salt is used to replace the calcium and magnesium ions on the resin material, thus allowing the resin material to again soften additional hard water. These water softening systems require systems to allow various types of water flow, for example a “service” flow where hard water from a ground water source is routed through the resin tank and then the softened water is routed (through a plumbing system interface) into the household or building internal plumbing system. The systems may also utilize a flow to allow the creation of brine by filling a brine tank with a controlled amount of water, a flow to draw the brine solution into the resin tank, a flow to slowly drive the brine through the resin bed in the resin tank, a flow or flows to flush any remaining brine solution out of the resin tank at the end of the regeneration cycle, a reverse flow through the resin bed to remove any debris or sediment, and the like.

Water softening systems generally stay in the “service” flow position as this is the most commonly used operation mode of the system, and only change to the other flow positions when needed. Thus, a number of systems have been developed to control the flow of water by moving the components of the system and determining when the system is in the “home” or service orientation, and when the components of the system have been configured to be in another flow position.

In some water softening systems, two slots and switches are used to control the flow of water in the system. For example, in some systems a rotating cam simultaneously engages two mechanical switches. One of the switches solely indicates whether the system is “home” or “not home,” where “home” means the system is in the “service” flow position. A second switch indicates that the system is or is not in a regeneration position. In such systems, however, one regeneration position cannot be distinguished from any other except counting from the home switch down every other switch operation and then determining what each particular switch operation indicates. Therefore, after any memory loss event, the system must recalibrate to “home,” and thus requires inefficient movement of the cam, regardless of its relative position.

Other systems utilize a rotating cam with a series of cylindrical features, each of which engages a mechanical switch. Each cylindrical feature has high and low portions on its circumference, causing the switch to be either “closed” or “open.” The combination of switch open/closed signals provides a digital code for each position. These positions, however, are not very accurate as the initial moment any switch moves the system determines it has changed state and is in the subsequent position, meaning the entire zone of possible motion until the next change of switch state has the same digital code. Thus, after any memory loss event these systems may not accurately reflect the actual position of the system components.

Other systems utilize rotary discs with a series of uniformly placed slots that rotate through an optical sensor that detects light passing through the rotating disc. One slot is larger than the rest to indicate the “home” position, and all other regeneration positions are identified by counting the number of slots detected after the home position. These systems, however, require recalibration every time the components need to change orientations by detecting the calibration reference, i.e. the “home” slot, because the “home” position cannot be determined with certainty except by movement of the disc. Thus, each regeneration cycle has to start by moving the disc back to the starting position to confirm it to be the “home” position. Only then can the system rotate the disc and subsequently detect and count all the subsequent slots to determine the position of the disc, and when it has rotated to a desired position. This requires inefficient rotation and adds time to the procedure since the system must check for home before initiating the procedure. Moreover, the speed of the rotation in these systems may vary, particularly when the system uses a DC motor, as is typical, and the system therefore may not properly detect or interpret all the slots, as the slot width is determined by the time it takes to traverse the optical sensor. For example, if the speed is too fast the system may not detect a slot, or if it is too slow may misinterpret another slot as the “home” position.

In addition, water softening systems already exist to assist homeowners with remotely viewing the display component of the water treatment unit. Some such systems permit homeowners to both view the status of the water treatment unit and control aspects of the operation of the unit, such as turn ON/OFF the unit. The homeowner manually views the status and reacts to the status by, for example, turning ON/OFF the unit or adding salt or other products to the water treatment unit. Some systems may sound an alarm or generate an e-mail when the status of the water treatment unit is outside particular parameters. Such systems create an added convenience for homeowners; nevertheless, they leave much room for improvement.

### SUMMARY

This Summary provides an introduction to some general concepts relating to this disclosure in a simplified form that are further described below in the Detailed Description. This summary is not intended to identify key features or essential features of the claimed subject matter, nor is it intended to be used to limit the scope of the claimed subject matter. Moreover, one or more of the steps and/or components described above may be optional or may be combined with other steps.

In one example, a water treatment system is disclosed comprising: a brine tank; a resin tank; a water supply interface; a drain interface; a plumbing system interface; a valve assembly coupled to at least two of: the brine tank, the resin tank, the water supply interface, the drain interface, and the plumbing system interface; a location determination component; a wireless communication component; a processor communicatively coupled to the wireless communication component and the location determination component; and a non-transitory memory storing executable instructions that, when executed by the processor, causes the water treatment system to perform various steps. Some examples of those steps include, but are not limited to: measuring a status of the water treatment system, and transmitting, by the wireless communication component to a remote server, the status of the water treatment system.

In another example, a method is disclosed comprising steps of: determining, by a location determination component in a water treatment system, a location of a water treatment system; transmitting the location to a remote server configured to determine an address corresponding to the location using a reverse geocoding server; receiving the address corresponding to the location of the water treatment system; and storing the address in memory at the water treatment system. Furthermore, the method may comprise additional steps of: toggling a wireless communication component in the water treatment system between a first mode and a second mode; when in the second mode, transmitting, by the wireless communication component to a mobile computing device in a vicinity of the water treatment system, a status of the water treatment system, wherein the status of the water treatment system comprises a location of the water treatment system; and when in the first mode, transmitting, by the wireless communication component to the remote server, the status of the water treatment system.

The illustrative method may further include steps of: measuring, by at least one flow measurement component, a flow of water through the water supply interface of the water treatment system; measuring, by at least one temperature measurement component, a temperature of the water through the water supply interface of the water treatment system; and transmitting, by the wireless communication component to the remote server, the measured temperature of the water and the measured flow of the water. As a result, a remote server may compare the measured temperature of the water and the measured flow of the water to historical measured values to generate a notification comprising an indication that a water supply line providing the water through the water supply interface is becoming frozen. The notification may be sent to various devices, including a user's computing device and/or a water treatment system.

The foregoing serves as illustrative examples of just some of the methods, apparatuses, and systems that are disclosed herein, and the disclosure is not so limited. Other methods, apparatuses, and systems are contemplated by the disclosure and would be apparent to a person skilled in the art after review of the entirety disclosed herein.

### BRIEF DESCRIPTION OF THE DRAWINGS

Exemplary embodiments of the disclosure will now be described by way of example only and with reference to the accompanying drawings, in which:

FIG. 1 illustrates an exploded perspective view of components of an illustrative embodiment of a water softening system;

FIG. 2 illustrates an exploded perspective view of components of an illustrative embodiment of a water softening system;

FIG. 3 illustrates a view of example rotatable elements and other components of an illustrative embodiment of a water softening system;

FIG. 4 illustrates a view an illustrative embodiment of a rotary position sensor and example rotational positions for use in a water softening system;

FIG. 5 illustrates example components for use with an example rotary position sensor;

FIG. 6 illustrates a cross-sectional view of an embodiment of a water softening system, where in this example the rotatable elements and valve assembly are configured so that the water softening system is in a “service” mode;

FIG. 7 illustrates a cross-sectional view of an embodiment of a water softening system, where in this example the rotatable elements and valve assembly are configured so that the water softening system is in a “brine flow” mode;

FIG. 8 illustrates an exploded perspective view of components of an illustrative embodiment of a water softening system;

FIG. 9 illustrates side view of an assembled illustrative embodiment of a valve control system for use in a water softening system; and

FIG. 10 illustrates an enhanced, networked water treatment system in accordance with various aspects of the disclosure;

FIG. 11 illustrates various examples of communication between a water treatment system and a remote server.

FIG. 12A and FIG. 12B illustrate a network diagram of an illustrative water treatment system 1000 in operational/normal mode and direct/repair mode, respectively.

FIG. 13 is a flowchart showing some illustrative steps performed by a water treatment system in accordance with various aspects of the disclosure.

FIG. 14 illustrates a network diagram showing communication between various external servers and a remote server in communication with a water treatment system.

FIG. 15A, FIG. 15B, FIG. 15C, and FIG. 15D are illustrative graphical user interfaces (GUIs) displayed on a user computing device in accordance with various aspects of the disclosure.

### DETAILED DESCRIPTION OF EMBODIMENTS

Existing liquid treatment systems (e.g., water treatment systems) may be enhanced by incorporating particular features described herein. For example, a water treatment system may be enhanced by incorporating a location determination component that, inter alia, determines a location of the water treatment system. The location may be determined automatically and obviate the need for a user to manually enter zip code information or the like, thus alleviating a burden on the user as well as reducing user error, whether inadvertent or malicious. Furthermore, the location determination component may be used to periodically, or in response to a triggering event, monitor the location of the water treatment system. As such, a data store (e.g., database) of location information may be created comprising current and/or historical location of the water treatment system. Using storage and/or transmission capabilities (e.g., a wireless communication component) comprised in the water treatment system (e.g., a networked water treatment system), the data store may be transmitted to a remote location (e.g., a centralized, remote computing device) for, inter alia, storage, aggregation, filtering, and/or analysis.

The location information may form some or all of the status (e.g., status information) of the water treatment system. In some examples, the status of the water treatment system may also include values measured by one or more measurement components, such as, but not limited to, one or more location determination components, one or more flow measurement components, one or more temperature measurement components, one or more pH measurement components, one or more composition measurement components, and/or combinations thereof. The plurality of components may measure, e.g., characteristics of the liquid (e.g., water) in the water treatment system and/or status of the water treatment system, and store the measured, time-stamped data in a data store. Using transmission capabilities (e.g., a wireless communication component) accessible to the water treatment system (e.g., a networked water treatment system), the data store may be transmitted to a remote location (e.g., a centralized, remote computing device) for, inter alia, aggregation, filtering, and/or analysis. Collectively, the aggregate data from a plurality of networked water treatment systems may form a repository of information that offers synergistic benefits that improve numerous aspects of water treatment systems and the related systems and users to which those water treatment systems provide service.

The embodiments, apparatuses and methods described herein provide, inter alia, systems, components, and methods related to water treatment, water softening and/or valve control systems and methods. These and other aspects, features and advantages will be further understood by those skilled in the art from the following description of exemplary embodiments. It is to be further understood that the systems, apparatuses and methods are capable of other embodiments and of being practiced and carried out in various ways.

In the following description of various examples of systems and methods of the this disclosure, reference is made to the accompanying drawings, which form a part hereof, and in which are shown by way of illustration various example structures and environments in which aspects of the disclosure may be practiced. It is to be understood that other structures and environments may be utilized and that structural and functional modifications may be made from the specifically described structures and methods without departing from the scope of the present disclosure. Moreover, the figures of this disclosure may represent the scale and/or dimensions according to one or more embodiments, and as such contribute to the teaching of such dimensional scaling. However, those skilled in the art will readily appreciate that the disclosure herein is not limited to the scales, dimensions, proportions, and/or orientations shown in the figures.

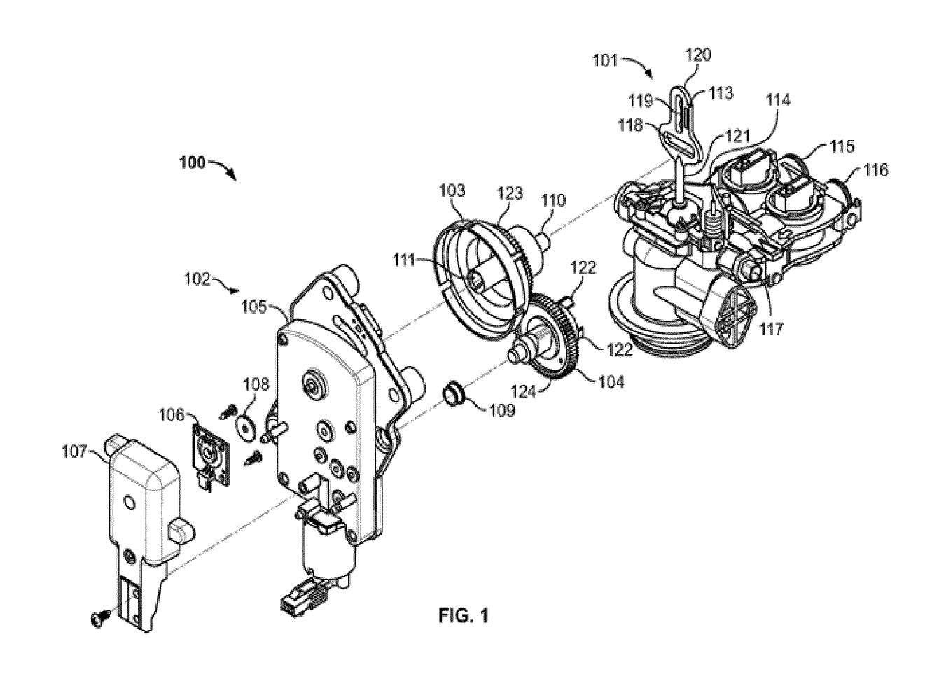

Some exemplary aspects relate to water treatment systems. In certain examples, the water treatment systems are water softening systems, while in others they are water filtering systems. In some embodiments of water softening systems, the water softening system comprises a valve assembly, a valve control system, a brine tank, a resin tank, or a combination thereof. FIG. 1 shows an exemplary embodiment 100 of a water softening system including a valve assembly 101 and a valve control system 102. In this example, the valve control system comprises a first rotatable element 103, a second rotatable element 104, a gear motor 105, and a rotary position sensor 106, where the rotary position sensor 106 may also include a rotary position sensor housing 107 and a wiper disc 108, and the valve control system may also comprise a shaft bushing 109 for the second rotatable element 104. In the example of FIG. 1, the first rotatable element comprises a cam 110 and a shaft housing 111, and the system also comprises a sensor shaft 112 (not visible in this view), which may comprise or be integrally or operably connected to a contact wiper. In this example, the valve assembly 101 includes a first moveable element 113, a second moveable element 114, an outlet port 115, an inlet port 116, and additional system ports 117.

In this example, the valve assembly 101 is an assembly for use in a water softening system, while in other embodiments of the disclosure, the valve assembly may be used to control the flow of liquids and/or gases for other purposes. In some examples of the system, the first moveable element 113 is operably connected to the first rotatable element 103 of the valve control assembly. The operable connection may be direct, i.e. the rotatable element is in physical contact with the first moveable element, or indirect, i.e. via one or more connecting components.

In certain embodiments, the first moveable element is configured to move between an initial position corresponding to an initial rotational position of the first rotatable element, and one or more subsequent positions corresponding to one or more subsequent rotational positions of the first rotatable element. For example, in the embodiment shown in FIG. 1, the cam 110 of the first rotatable element fits in a cam cavity 118 of the first moveable element. As the cam rotates with the first rotatable element, the vertical translation of the cam is imparted to the first moveable element 113, moving it up and down relative to the main body of the valve assembly.

In this example embodiment, the first moveable element is a piston. In some embodiments, the first moveable element comprises or consists of a metal, a metal alloy, plastic, or a combination thereof. In certain embodiments, the element comprises one or more gaskets, for example one or more gaskets made from rubber, silicone, plastic, or a combination thereof. The first moveable element may have a variety of shapes and sizes depending on the characteristics and purposes of the valve assembly. In this exemplary embodiment, the element comprises an upper portion 119 comprising a cam cavity 118 and a second cavity 120, and an intermediate portion 121 connected to the lower piston portion controlling flow within the valve assembly. In certain examples, the intermediate portion may comprise the piston portion. In various embodiments, the piston is essentially cylindrical and has one or more flow passages or cavities, while in others it has one or more concave areas, one or more indentations, or a generally undulating shape to allow flow of materials around a portion or portions of the piston.

In this example, and as described in more detail herein, the various positions of one or more pistons allow and/or block certain flow channels within the valve assembly as needed by the water treatment system or other systems. For example, one position of the first movable element or piston may allow incoming ground water to flow into the resin tank to be treated by the resin in the tank, and then routed out into an internal plumbing system of a building or household. As another example, another position of the first moveable element or piston may allow water to flow into a brine tank of the water softening system to create brine by mixing with salt stored in the brine tank. As yet another example, another position of the first moveable element or piston may allow, after the regeneration of the resin material with brine, to drain the brine solution and the hard ions out of the resin tank.

In some examples, the valve assembly includes a second moveable element, such as the second moveable element 114 shown in FIG. 1. In certain embodiments, the second moveable element is operably connected to the second rotatable element such that as second rotatable element rotates, the second moveable element of the valve assembly moves between two or more positions. The operable connection of these elements, or any other elements described herein as “operably connected” or with similar language, may be direct or indirect. For example, in the example of FIG. 1, the second rotatable element 104 comprises a pair of projections 122 that, in some rotational orientations, press down on the second moveable element, causing it to move vertically downward into a downward position. In this example, the second moveable element acts as a brine tank valve of the valve assembly that may open and close to allow the flow of water into the brine tank, or the flow of brine out of the brine tank, as it moves up and down (a “brine flow” position refers to the orientation of the second moveable element that allows the flow of liquid into or out of the brine tank through the valve assembly). Thus, in some embodiments the second moveable element is configured to open or close a brine tank valve of the valve assembly.

In certain examples, the valve assembly includes one or more ports. In this exemplary embodiment, the assembly includes an outlet port 115, and an inlet port 116, and one or more additional system ports 117. In some examples, the inlet port is configured to receive hard water from a ground water source, such as a water main supply line, and the outlet port is configured to outflow treated, softened water into, for example, an internal building plumbing system, such as a household plumbing system. In this example, an additional system port 117 is configured to be connected to a brine tank. In certain examples, one or more additional service ports are configured to be connected to a resin tank, a drain interface, a water filter, or a combination thereof. In some embodiments, regardless of whether ports or some other connection features are used, the valve assembly is configured to be independently connected to a brine tank, a resin tank, a water supply interface, a drain interface, an internal plumbing system interface, a water filter, or a combination thereof. In certain examples, the service ports or other connections comprise a fastener. In some embodiments, the fastener is an internal thread, an external thread, a clamp, or a collar.

A variety of valve assemblies (e.g., a PENTAIR® 5000 assembly) may be used in embodiments of the systems, as would be apparent to a skilled artisan given the benefit of this disclosure.

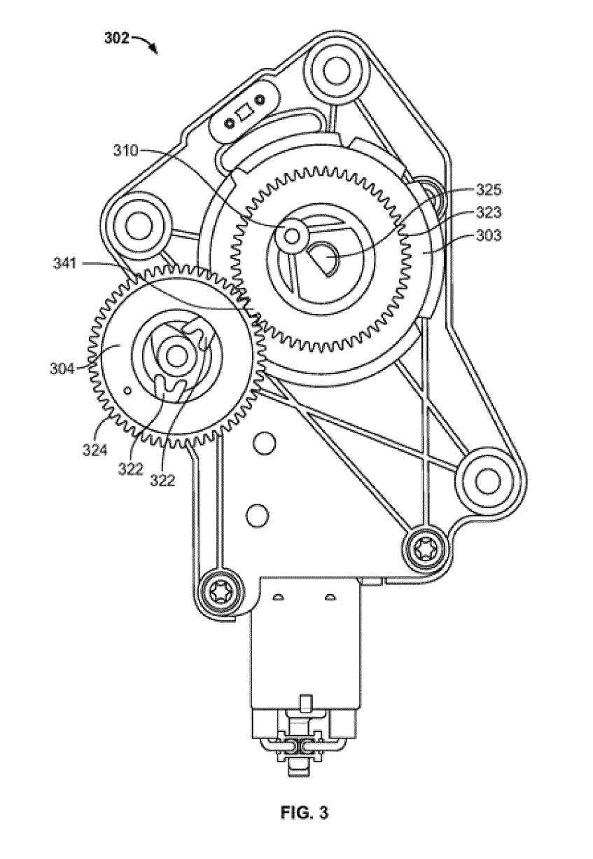

In the example of FIG. 1, the valve control system 102 is configured to control the movement and position of one or more valves in a water softening system, while in other embodiments the control system may be configured to control the flow of liquids and/or gases for other purposes. In this example, the first rotatable element is a circular element comprising gear teeth 123 around a portion of its circumference configured to interact with gear teeth 124 of the second rotatable element 104 such that the second rotatable element rotates when the first rotatable element is rotated. In certain examples, such as the example embodiment of FIG. 3, one or both of the rotatable elements comprise a structure or structures that assist in the proper alignment of the rotatable elements, such as a differently sized and/or shaped tooth, a key structure, corresponding shapes and/or projections, and the like. In the example of FIG. 3, the first rotatable element 303 comprises a key tooth 341, and the second rotatable element 304 comprises a corresponding gap in its gear teeth 324 sized and shaped to receive the tooth. In other examples, the first rotatable element comprises some other connection feature or component, such as a belt connected to the first rotatable element and the second rotatable element. In some examples, the first rotatable element is or comprises components that are circular, while in others it is or comprises components that are elliptical in shape, or are a geometric shape.

As discussed above, in certain embodiments the first rotatable element is operably connected to the first moveable element of the valve assembly, for example through the cam 110 of FIG. 1 or a similar structure. In other examples, the operable connection is through one or more arms or projections, or a combination of any of the above structures. In some examples, the operable connection comprises features or components that convert the rotary motion of the first rotatable element into linear motion of the first rotatable element. In certain embodiments, the operable connection is such that the full range of linear motion of the first moveable element corresponds to a full revolution of the first rotatable element, and thus the relative linear position may be correlated to the angular position of the first rotatable element. In various examples, the first rotatable element is configured to, via the operable connection, move from an initial rotational position to one or more subsequent rotational positions. In certain examples, the element is configured to move to two or more subsequent rotational positions, in certain examples, three or more, in still others four or more, and in yet others five or more.

In some examples the first rotatable element comprises a housing for a shaft or axle, such as a sensor shaft, or another material operably connected to a sensor shaft and/or a contact wiper. In the example of FIG. 1, the housing is a shaft housing 111 shaped and sized to contain a shaft comprising a sensor shaft, or a shaft operably connected to a sensor shaft.

Through an operable connection with the first moveable element, the first rotatable element may then move the moveable element between an initial position that corresponds to the initial rotational position of the rotatable element and one or more subsequent positions, each corresponding to one or more subsequent rotational positions of the first rotatable element.

In some examples, the valve control system comprises a second rotatable element, such as the element 104 of FIG. 1. In some examples, the second rotatable element is operably connected to the first rotatable element via a connection feature or component, such as gear teeth 124 which interface with gear teeth 123 of the first rotatable element. In certain examples, the second rotatable element is also operably connected to the second moveable element of the valve assembly, such that is may move the second moveable element as discussed above. In some embodiments, the second rotatable element is only operably connected to the second moveable element in some rotational positions, or the manner of connection changes, for example another component or feature of the second rotatable element comes into contact with the second moveable element at certain rotational positions. For example, in the example of FIG. 1, the projections 122 come into contact with the second moveable element to push it down into the valve assembly in certain rotational positions for the second rotatable element.

In some examples, the valve control system comprises a motor, such as a gear motor 105 in the example of FIG. 1, which causes the first rotatable element to rotate when the motor is activated. In certain examples, the motor utilizes direct current, while in others it utilizes alternating current. In some examples, the motor is configured to allow the first rotatable element to rotate in both a clockwise and counterclockwise direction. In some examples, the motor is configured to rotate in a single direction.

In certain examples, the valve control system comprises a rotary position sensor, such as the sensor 106 of the embodiment in FIG. 1. In some examples, the rotary position sensor is operably connected to the first rotatable element. In various examples, the rotary position sensor is configured to detect the rotational position of the first rotatable element. The detection may be direct, i.e. the rotational position of the element itself or a component thereof is detected, while in others it is indirect, i.e. the rotational position of another component that rotates along with the first rotatable element is detected by the rotary position sensor.

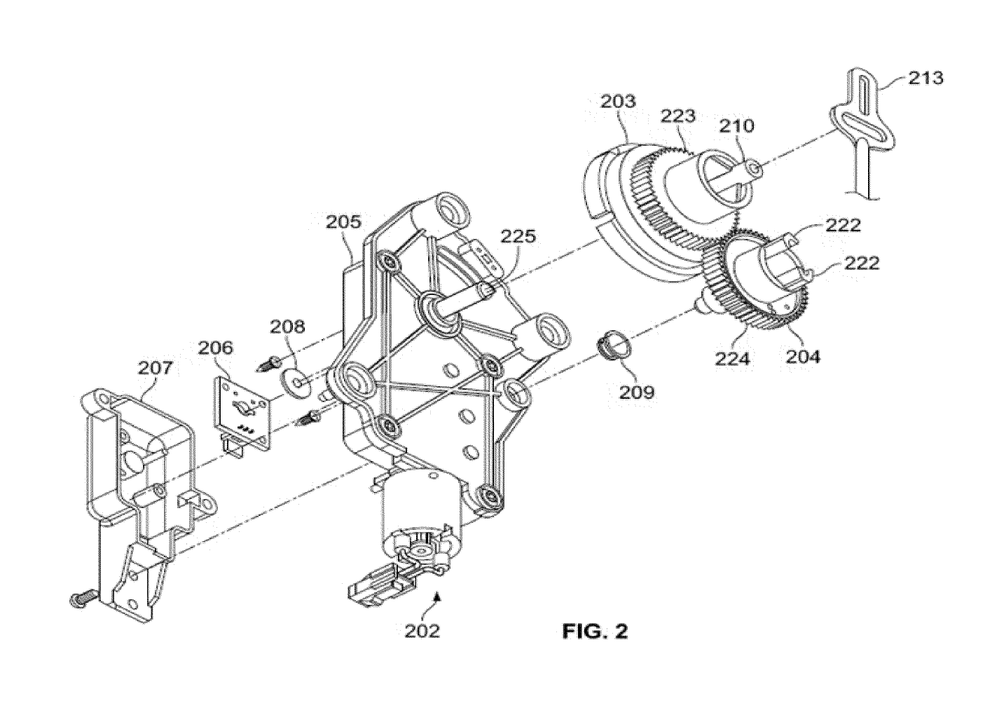

For example, FIG. 2 shows an exemplary embodiments of the valve control system comprising a shaft 225 that is housed within a shaft housing 211, (not visible in this view) of the first rotatable element 203 and rotates along with the first rotatable element (for ease in comparison of the illustrated embodiments in this and other Figures, the components in the shown embodiments that are similar to those in the previously shown embodiments have been given the same ten and one digit reference numerals as the components of other example embodiments, and given a hundred digit reference number corresponding to the number of the Figure—for example the first rotatable element is labelled 104 in the embodiment of FIG. 1, the analogous example element in FIG. 2 is labelled 204, the analogous example element in FIG. 3 is labelled 304, and so on).

In some embodiments, the component that is detected by the sensor is at least partially contained within the rotary position sensor, while in others it is in contact with at least a portion of the sensor. In still others it is indirectly connected to the sensor, and in yet others, where the sensor can detect one or more components not in physical contact with the sensor, such as sensors utilizing magnets, it is otherwise adjacent or nearby the sensor. In some examples, the sensor may measures a property where the property values may fall somewhere on a continuum based on the possible rotational positions of the element or component. For example, in some embodiments the sensor measures an electrical resistance, while in others it measures the strength of a magnetic field.

In some embodiments, the sensor detects the rotational position of a sensor shaft, such as sensor shaft 112, by measuring an electrical resistance. In certain examples, the rotary position sensor comprises a resistive material capable of conducting an electric current and having an electrical resistance when an electric current is applied, and the first rotatable element comprises a contact wiper, or is integrally or operably connected to a contact wiper. The contact wiper may be configured to rotate with the first rotatable element through an integral or operable connection. In some examples, the resistive material may have a shape corresponding to a portion of the circumference of a circle. The resistive material may be any material that has the appropriate electrical conduction and resistance properties, and may comprise or consist of a metal and/or transition metal, including, but not limited to, copper, aluminum, tin, steel, platinum, silver, iron, gold, brass, bronze, zinc, and/or nickel, or alloys thereof. In some examples, the material may comprise or consist of carbon particles, carbon fibers, carbon nanofibers, carbon nanotubes, and/or graphene. In certain embodiments, the material comprises a conductive polymer, such as polyaniline.

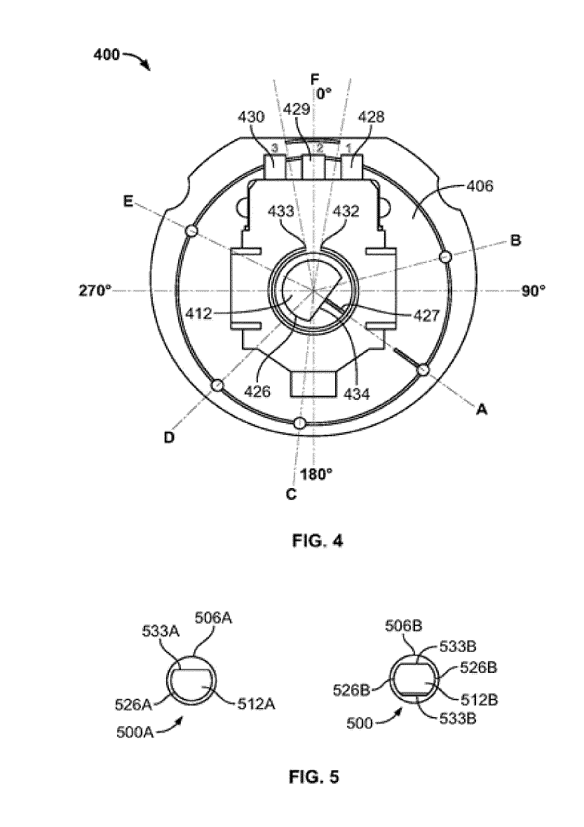

FIG. 4 shows an exemplary embodiment of a sensor 400 including a resistive material comprising a first end 432 and a second end 433. In this example, the first rotatable element is connected, via a sensor shaft 412, to a contact wiper 427. In some examples, the contact wiper is configured to rotate with the first rotatable element and, in at least some of its rotational positions, contact the resistive material between the first end and the second end. The rotary position sensor may be configured to apply an electric current to the resistive material and measure the electrical resistance of a portion of the resistive material between an end of the resistive material and the contact wiper to detect the rotational position of the first rotatable element. For example, the sensor may comprise electrical terminals connected to the first and second end of the resistive material and the contact wiper. In the example of FIG. 4, a first terminal 428 is connected to the first end of the resistive material, a second terminal 429 is connected to the contact wiper, and a third terminal 430 is connected to the second end 430. As the sensor shaft 412 rotates, the contact wiper 427 comes into contact with the resistive material, and therefore an electrical resistance between an end of the resistive material and the contact wiper may be measured. As the distance between them increases, requiring the current to travel through a larger portion of the resistive material, the relative value of the electrical resistance also increases. In examples where a constant voltage is supplied between the two ends of the resistive material, the wiper effectively acts as a voltage divider and the voltage at the position of the wiper is proportional to its relative angle to the ends of the resistive material.

Thus, in some examples, the rotary position sensor may be configured to, when the contact wiper is in at least some of its possible rotational positions, apply an electric current and measure the electrical resistance of a portion of the resistive material, where the size of the portion depends on the position of the wiper. The relative strength of the resistance may then be used to determine and detect the rotational position of the first rotatable element. In some examples, the sensor includes a “dead zone,” for example the zone indicated by position F in FIG. 4, where no electrical resistance is measured because the contact wiper is not in contact with the resistive material when in any of the rotational positions in between the two ends of the resistive material. As the wiper rotates around the 360 possible degrees of rotation, it comes into contact with the resistive material, allowing a measured electrical resistance value, and the resistance increases as it moves along the material until the wiper again reaches the “dead zone” where the contact wiper is not in electrical contact.

In some examples, and as described in more detail herein, a range of measured electrical resistance values is used to detect whether the first rotatable element is an initial rotational position or one or more subsequent rotational positions. For example, the range of electrical resistance that corresponds to the contact wiper being approximately 125-130 degrees from a reference point may be used to determine whether the contact wiper, and thus the first rotatable element, is in a particular position. In certain examples, the range, or “jog values” of electrical resistance correspond to approximately five degrees of rotation or less, approximately three degrees of rotation or less, approximately eight degrees of rotation or less, approximately ten degrees of rotation or less, or any other predetermined degree value or less. In some examples, the jog values provide a tolerance of plus or minus approximately 50 ohms from a resistance corresponding to a particular rotational position, in others a tolerance of plus or minus approximately 100 ohms, in others a tolerance of plus or minus approximately 250 ohms, in others a tolerance of plus or minus approximately 500 ohms, and in still others a tolerance of plus or minus a predetermined ohm value. In certain embodiments, the tolerance is approximately 1000 ohms or less, in others approximately 750 ohms or less, in others approximately 500 ohms or less, and in still others approximately 250 ohms or less.

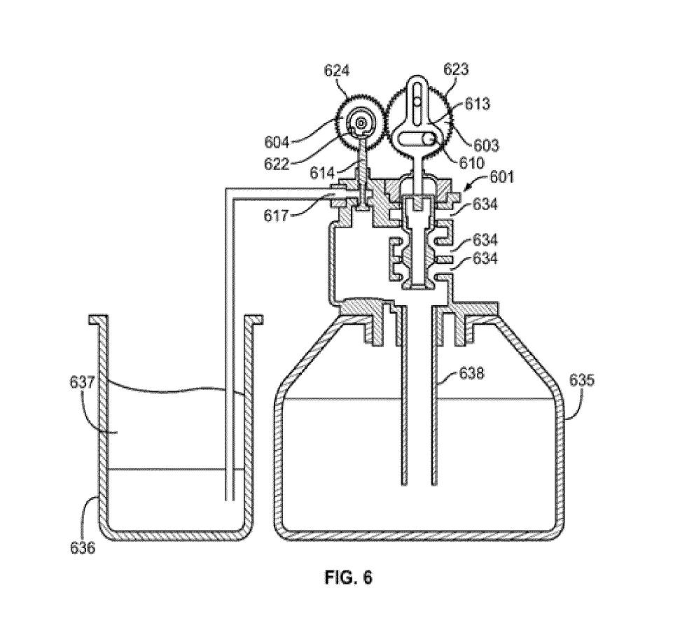

The sensory shaft may have a variety of shapes allowing the selective contact of the contact wiper. In some embodiments, the sensor shaft or a portion thereof has a cylindrical shape, and in some examples the contact wiper may be on top of an exterior portion of the cylindrical surface. In certain embodiments the sensor shaft or a portion thereof has a generally cylindrical shape with an indentation or channel, or where a section of the cylinder is removed to provide a space for the contact wiper. For example, sensor shaft 412 comprises a generally circular perimeter shape 426 and a flat section 434 connected to the contact wiper 427. In some examples, the generally circular perimeter helps guide the rotation of the sensor shaft within the position sensor. FIG. 5 provides other exemplary embodiments of the sensor shaft 500A and 500B, where shaft 512A has a circular perimeter section 526A and a flat section 533A contained within a cavity of rotary position sensor 506A. Shaft 512B has two circular perimeter sections 526B and two flat sections 533B contained within a cavity of rotary position sensor 506B.

In some examples, the rotary position sensor is a Panasonic EVWAE/D sensor. In some embodiments, the total resistance range is approximately 0 to 5,000 ohms, while in others it is approximately 0 to 10,000 ohms, and yet still in others it is a range from a predetermined first ohm value to a second ohm value.

In some examples, the system may comprise at least one computer processor and at least one non-transitory computer-readable medium having stored therein computer executable instructions, that when executed by the at least one processor, cause the water softener system to perform various functions. Aspects of the steps described herein may be executed using one or more computer processors. Such processors may execute computer-executable instructions stored on non-transitory computer-readable media. For example, the water softening system may comprise a computing device for controlling the overall operation of the system and its associated components. The device may include a computer processor, RAM, ROM, one or more input/output modules, and one or more non-transitory computer-readable media. Any suitable computer readable media may be utilized, including various types of tangible and/or non-transitory computer readable storage media such as, Flash memory/EEPROM, hard disks, and the like. The one or more media may store computer-readable instructions (e.g., software) and/or computer-readable data (i.e., information that may or may not be executable), which may provide instructions to the processor for enabling the system to perform various functions.

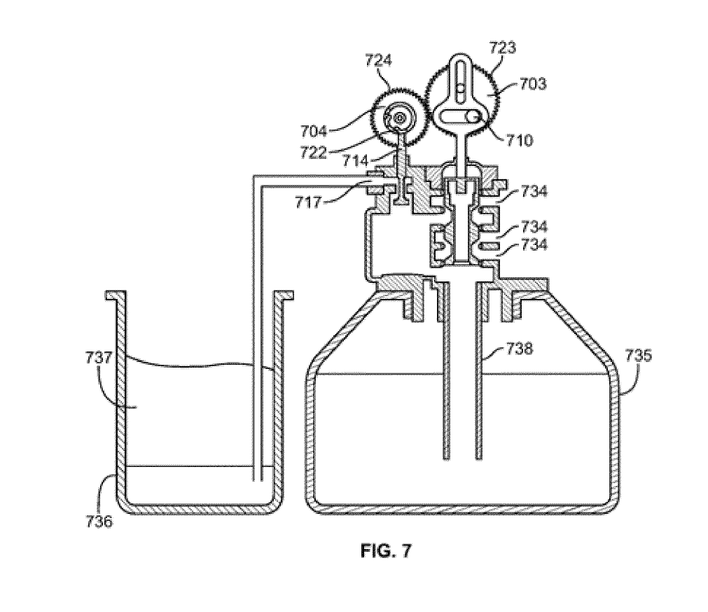

In various examples, the computer executable instructions, when executed by the at least one processor, cause the water softener system to perform various functions. For example, the instructions may cause the system to rotate the first rotatable element from an initial rotational position to one or more the subsequent rotational positions, and cause the rotary position sensor to determine when the first rotatable element is in one of the subsequent rotational positions. For example, the first rotatable element may be in an initial position corresponding to a “service” mode of the valve assembly. In the example of FIG. 4, position A denotes this home or service position, and the contact wiper 427 is in position A relative to the dead zone, and thus the rotary position sensor measures a certain resistance value based on the position of the wiper. The measured resistance may correspond to a saved value or range of electrical resistance values stored on the readable media such that the computer processor may detect and verify that the first rotatable element is in the home or service position (as illustrated in FIG. 6 showing the valve assembly when the first rotatable element is a rotational position where the first moveable element is positioned to allow the service flow of water thought the valve assembly based on its position relative to plurality of channels 634). In some examples, when the instructions are executed, the first rotatable element is then rotated to one or more subsequent positions, as determined by the measured electrical resistance, which in turn may cause the first and/or second rotatable element to move to allow different flows though the valve assembly as described above.

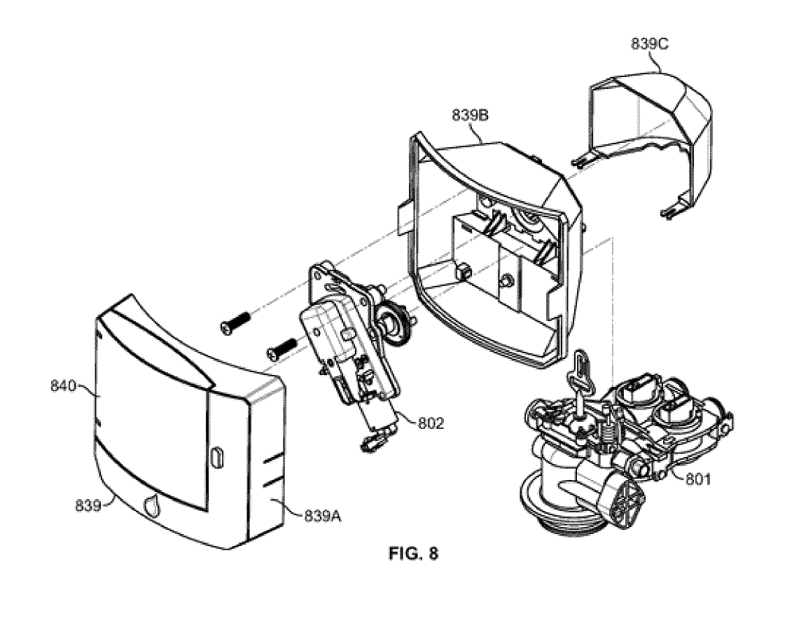

For example, when a user desires to regenerate the resin of the water softening system, or when the system automatically determines the resin should be regenerated (based on, e.g. the passage of time, by detecting how much water has been used since the last regeneration, or other criteria), the rotatable elements may move as needed to allow the various flows required for a regeneration cycle. As one representative example, FIG. 4 illustrates the possible positions of the first rotatable element for such a cycle. In this example, the instructions, when executed by the processor, cause the system to activate the gear motor and rotate the element in a counterclockwise direction from position A to position B, where the processor determines whether the element is in position B by monitoring the measured electrical resistance via the rotary position sensor. By this rotation, the second rotatable element is also rotated through the operable connection to the first rotatable element such that the second moveable element opens a brine tank valve (as illustrated in FIG. 7 showing the valve assembly when the first rotatable element is in a brine flow position) allowing the brine tank to fill up with water which then dissolves sodium salt stored in the brine tank to create a brine solution.

In some examples, the instructions cause the system to activate the gear motor and rotate the element in a clockwise direction back to position A while the brine solution is being created. In various examples, the water remains in the brine tank for approximately two hours to sufficiently dissolve a sufficient amount of the salt, but any time interval appropriate for the creation of brine may be used depending on the characteristics of the system. The instructions may then cause the system to activate the gear motor and rotate the first rotatable element in a clockwise direction to a subsequent position C, where the operable connection to the first moveable element causes it to move to a position allowing any water in the resin tank to drain out.

The instructions may then cause the system to activate the gear motor and rotate the first rotatable element in a clockwise direction to a subsequent position D, where the operable connection to the first moveable element and, ultimately, the second moveable element via the second rotatable element, causes them to move to positions allowing the created brine solution to flow into and through the resin of the resin tank, and then out through a drain interface (i.e. a “brine draw/slow rinse” rotational position of the possible “brine flow” rotational positions) to flush the hard ions and excess brine from the resin in the tank. The instructions may then, after a sufficient amount of time has passed to regenerate the resin, cause the system to activate the gear motor and rotate the first rotatable element in a clockwise direction to a subsequent position E to rinse the now regenerated resin to remove any remaining brine/hard ion solution and help settle the resin bed. The instructions may then cause the first rotatable element to return to home/service position A. In some embodiments, the direction of rotation may always be in one direction (e.g. clockwise), or may vary as appropriate to minimize the distance travelled between desired positions. In various examples of water filtering systems, the system is configured to move between positions providing a “backwash” flow, i.e. a reverse flow through a water filter to remove any debris and/or sediment, a “fast rinse” flow to rinse the filter, and a “service” flow for general use.

By being able to measure the electrical resistance whenever desired, the system may be able to determine the rotational position of the first rotatable element, and thus may directly rotate the element to a different position without any/minimal recalibration, or without searching for one or more particular reference points. In other words, the systems allow changes in valve flow without the need for recalibration or unnecessary and excessive motion of the components of the system, even if there is a memory loss event. This disclosure contemplates that various embodiments that the system may be capable of immediately determining if the first rotatable element is in an initial position or any particular subsequent position, without, for example, recalibration. Relatedly, this disclosure contemplates that in various embodiments the rotary position sensor may be configured to detect the rotational position of the first rotatable element, whether in the initial rotational position or one of the subsequent rotation positions, during use of the system without recalibrating to a reference position.

This disclosure also contemplates that in some examples the system may be capable of rotating the first rotatable element from one position directly to any other desired rotational position, whether, for example, directly back to the initial position (for example, position A of FIG. 4) or a subsequent rotational position (for example, position E of FIG. 4). Relatedly, this disclosure contemplates that various embodiments of the system may be configured to rotate the first rotatable element from one desired position (e.g. an initial or subsequent rotational position allowing a particular flow of a valve assembly) to another desired position without any rotational motion beyond the rotation to traverse the number of degree(s) formed by the angle between the two positions. This disclosure further contemplates that various embodiments of the system may be capable of directly rotating the first rotatable element in any direction as appropriate to minimize the distance traveled between rotational positions (for example, counterclockwise between positions A and B of FIG. 4, and then clockwise between positions C and D of FIG. 4).

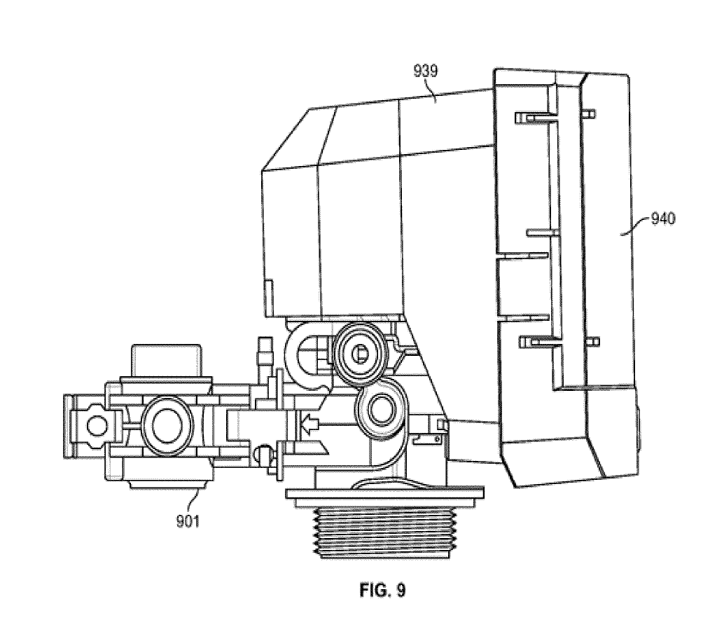

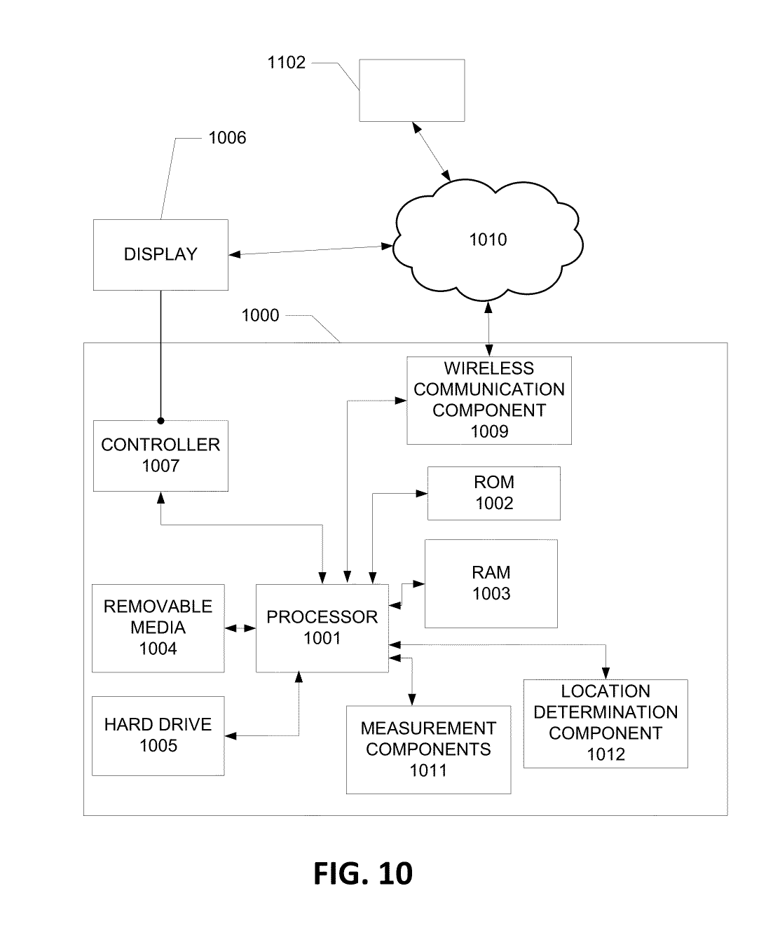

In some examples, the system comprises rotary position sensor housing, such as the housing 107 shown in FIG. 1. The housing may consist of or comprise any suitable material, for example a thermoplastic or metal material. In some embodiments, the housing is a injection molded plastic. In various examples, the system further comprises a wiper disc, such as the disc 108 in FIG. 1. The disc may be any suitable material that assists in preventing grease of other materials from the gear motor from reaching the sensor area. In some examples, the system comprises one or more bushings for a shaft of one of the rotatable elements, for example the shaft bushing 109 of FIG. 1, to assist the rotation of the rotatable elements. In some examples, the system further comprises an exterior housing, such as the exterior housing shown in FIGS. 8 and 9. In some examples, the exterior housing comprises multiple sections, for example in the embodiment of FIG. 8, the exterior housing comprises a front housing 839A, a rear hosing 839B and a rear cover 839C. In certain examples, the housing or front section of the housing comprises a door, such as door 840. The door may be configured to be selectively opened by a user to access a control interface for the water softening system. The embodiment of FIG. 9 shows an assembled view of the exterior housing around the valve assembly 901 and the valve control system 902 (not visible).

As mentioned above, FIGS. 6 and 7 show exemplary embodiments of the water softening systems. The embodiment of FIG. 6 illustrates a valve assembly 601 where a first moveable element 613 is positioned in an initial position allowing service flow of water. The embodiment further comprises a rotatable cam 610 of a first rotatable element 603 operably connected to the first moveable element, and a second rotatable element 604 having projections 622 operably connected to a second movable element. The embodiment further comprises a plurality of channels 634 within the valve assembly, which may be connected to a plurality of ports and/or other end points, such as the brine tank port 617, which is connected to a brine tank 636 containing a sodium salt 637. This exemplary embodiment further comprises a resin channel 638 allowing the flow of water to and/or from a resin tank 635. As discussed above, as the first rotatable element 603 rotates from one position to another, the first and second moveable elements may move to corresponding positions via the operable connections. Based on the position of these elements, a particular flow path inside the valve assembly may be opened or blocked as needed based on the desired functionality. FIG. 7 shows a similar exemplary embodiment with analogous components, where in this exemplary embodiment the first rotatable element 703 is in a brine flow position and the second moveable element 704 is positioned such that the brine valve is open.

These descriptions of the water treatment system are merely exemplary. In certain embodiments, the water treatment and/or water softener systems comprise additional combinations or substitutions of some or all of the features and/or components described above. Moreover, additional and alternative suitable variations, forms, features and components will be recognized by those skilled in the art given the benefit of this disclosure. In additional, any of the steps described above, or below in connection with the valve control system or method examples, may be performed by the water treatment system, and vice versa.

Other exemplary aspects relate to valve control systems. Any of the features discussed in the exemplary embodiments of the water treatment systems may be features of embodiments of the valve control systems, and vice versa. Moreover, any of the steps described above or below in connection with the method examples may be performed by the valve control systems, and vice versa.

In some examples, the valve control system includes a first rotatable element configured to be operably connected to a first moveable element of a valve assembly, and configured to move from an initial rotational position to at least one subsequent rotational position. In certain embodiments, the valve control system further comprises a rotary position sensor operably connected to the first rotatable element and configured to detect the rotational position of the first rotatable element. In various examples, the rotary position sensor comprises a resistive material having an electrical resistance when an electric current is applied and having a first end and a second end. In certain examples, the first rotatable element comprises a contact wiper, or is integrally or operably connected to a contact wiper, and the contact wiper is configured to rotate with the first rotatable element. In at least some of its rotational positions, the contact wiper may contact the resistive material between the first end and the second end. In various examples of the valve control system, the rotary position sensor is configured to apply an electric current to the resistive material and measure the electrical resistance of a portion of the resistive material between an end of the resistive material and the contact wiper to detect the rotational position of the first rotatable element.

In some examples, the valve control system further includes a motor configured to rotate the first rotatable element. In certain examples it includes at least one computer processor and at least one non-transitory computer-readable medium having stored therein computer executable instructions. In certain examples, when the instructions are executed by the at least one processor, they cause the valve control system to rotate the first rotatable element from its initial rotational position to at least one subsequent rotational position, at least two subsequent rotational positions, or at least four subsequent rotational positions, where the rotary position sensor determines when the first rotatable element is in a particular subsequent rotational position.

In some examples, the instructions further cause the valve control system to rotate the first rotatable element from its initial rotational position to at least two subsequent rotational positions, wherein the rotary position sensor determines when the first rotatable element is in each of the at least two subsequent rotational positions, and where the valve control system is configured to rotate the first rotatable element directly from one subsequent rotational position to another subsequent rotational position.

In various embodiments, the system include a second rotatable element operably connected to the first rotatable element and configured to be operably connected to a second moveable element of a valve assembly. In certain examples the instructions further cause the valve control system to rotate the second rotatable element, via the first rotatable element, from an initial rotational position to at least one subsequent rotational position

In various embodiments, a range of measured electrical resistance values is used to detect whether the first rotatable element is in an initial rotational position or at least one subsequent rotational position. In certain examples, the contact wiper and the resistive material are configured such that the contact wiper is not in contact with the resistive material in at least some of its rotational positions.

These descriptions of the valve control system are merely exemplary. In certain embodiments, the valve control system comprises additional combinations or substitutions of some or all of the components and/or features described above. Moreover, additional and alternative suitable variations, forms, features and components for the valve control system, and steps capable of being performed by the valve control system, will be recognized by those skilled in the art given the benefit of this disclosure.

Other exemplary aspects relate to apparatuses. Any of the features discussed in the exemplary embodiments of the water treatment systems and/or valve control systems may be features of embodiments of the apparatus, and vice versa. Moreover, any of the steps described above or below in connection with the method examples may be performed by the apparatus examples, and vice versa.

Other exemplary aspects relate to methods, including methods of softening water and/or controlling flow through a valve assembly, for example a valve assembly of a water softening system or a water treatment system. In certain embodiments, the methods utilize any of the components and/or features described above in reference to embodiments of the water softening systems and/or valve control systems. Moreover, additional and alternative suitable variations, forms, features and components for use in the method will be recognized by those skilled in the art given the benefit of this disclosure.

In some examples, the method comprises rotating a first rotatable element operably connected to a first moveable element of a valve assembly from an initial rotational position to at least four subsequent rotational positions to move the first moveable element from an initial position, corresponding to the initial rotational position of the first rotatable element, to at least four subsequent positions corresponding to the at least four subsequent rotational positions of the first rotatable element. In certain embodiments the method includes detecting the rotational position of the first rotatable element through a rotary position sensor operably connected to the first rotatable element. In some examples, first rotatable element rotates directly from one subsequent rotational position to another subsequent rotational position.

In various embodiments a motor rotates the first rotatable element. In some examples at least one computer processor executes computer executable instructions stored on at least one non-transitory computer-readable medium to cause the motor to rotate the first rotatable element from the initial rotational position to one of the subsequent rotational positions. In certain embodiments they further cause the rotary position sensor to determine when the first rotatable element is in one of the subsequent rotational positions.

In certain examples, the rotary position sensor comprises a resistive material having an electrical resistance when an electric current is applied, the resistive material comprises a first end and a second end, the first rotatable element comprises a contact wiper, or is integrally or operably connected to a contact wiper, and the contact wiper is configured to rotate with the first rotatable element and, in at least some of its rotational positions, contact the resistive material between the first end and the second end. In various examples, the method further comprises applying an electric current to the resistive material and measuring the electrical resistance of a portion of the resistive material between an end of the resistive material and the contact wiper to detect the rotational position of the first rotatable element.

In some embodiments of the method, a second rotatable element is operably connected to the first rotatable element, a second moveable element of the valve assembly is operably connected to the second rotatable element, and the second moveable element is configured to open or close a brine tank valve of the valve assembly. In some examples, the method further comprises rotating the first rotatable element from the initial rotational position to at least one brine flow rotational position, wherein brine tank valve is open when the first rotatable element is in the at least one brine flow position. In various embodiments, a range of measured electrical resistance values is used to detect whether the first rotatable element is the initial rotational position or the at least four subsequent rotational positions. In some examples, the contact wiper and the resistive material are configured such that the contact wiper is not in contact with the resistive material in at least in at least some of its rotational positions.

In accordance with one exemplary aspect, a water treatment system is provided. In some examples, the water treatment system is a water softener system. In some examples, the water treatment system includes a first rotatable element operably connected to a first moveable element of a valve assembly and configured to move from an initial rotational position to at least two subsequent rotational positions, and further configured to move the first moveable element between an initial position corresponding to the initial rotational position of the rotatable element, and at least two subsequent positions corresponding to the at least two subsequent rotational positions of the first rotatable element. In certain examples the system includes a rotary position sensor operably connected to the first rotatable element and configured to detect the rotational position of the first rotatable element. In various embodiments, the valve assembly is configured to be independently connected to a brine tank, a resin tank, a water supply interface, a drain interface, a plumbing system interface, or a combination thereof. Similarly, in various embodiments, the valve assembly may be configured to be independently connected to at least two of: a brine tank, a resin tank, a water supply interface, a drain interface, and a plumbing system interface. In some embodiments, the system is configured to move the first rotatable element directly from one subsequent rotational position to another subsequent rotational position. In other words, the first rotatable element may be moved from one subsequent rotational position to another subsequent rotational position without rotating a full revolution (i.e., 360 degrees) or more. In certain examples, the rotary position sensor is configured to detect the rotational position of the first rotatable element during use of the system without recalibrating to a reference position.

In various embodiments, the system includes a motor configured to rotate the first rotatable element, at least one computer processor, and at least one non-transitory computer-readable medium having stored therein computer executable instructions. In some examples, when the instruction are executed by the processor, it causes the water treatment system to rotate the first rotatable element from the initial rotational position to one of the subsequent rotational positions, and the rotary position sensor determines when the first rotatable element is in one of the subsequent rotational positions.

In certain examples, the rotary position sensor comprises a resistive material having an electrical resistance when an electric current is applied, and the resistive material comprises a first end and a second end. In various embodiments the first rotatable element includes a contact wiper, or is integrally or operably connected to a contact wiper. The contact wiper may be configured to rotate with the first rotatable element and, in at least some of its rotational positions, contact the resistive material between the first end and the second end. In certain embodiments, the rotary position sensor is configured to apply an electric current to the resistive material and measure the electrical resistance of a portion of the resistive material between an end of the resistive material and the contact wiper to detect the rotational position of the first rotatable element.

In some embodiments, the system includes a second rotatable element operably connected to the first rotatable element, and a second moveable element of the valve assembly operably connected to the second rotatable element, where the second moveable element is configured to open or close a brine tank valve of the valve assembly. In various examples, computer executable instructions stored in computer memory of the water treatment system, when executed by a processor of the water treatment system, further cause the water treatment system to rotate the first rotatable element from the initial rotational position to at least one brine flow rotational position, wherein brine tank valve is open when the first rotatable element is in the at least one brine flow position. In certain examples, the instruction further cause the system to rotate the first rotatable element from the initial rotational position to at least four subsequent rotational positions, where the rotary position sensor determines when the first rotatable element is in each of the at least four subsequent rotational positions, and where the first moveable element of the valve assembly is configured to move to at least four subsequent positions corresponding at least four subsequent rotational positions of the first rotatable element.

In various examples, a range of measured electrical resistance values is used to detect whether the first rotatable element is the initial rotational position or the at least two subsequent rotational positions, or the at least four subsequent rotational positions. In certain embodiments, the contact wiper and the resistive material are configured such that the contact wiper is not in contact with the resistive material in at least some of its rotational positions.

In accordance with another exemplary aspect, a valve control system is provided. In some examples, the valve control system includes a first rotatable element configured to be operably connected to a first moveable element of a valve assembly and configured to move from an initial rotational position to at least one subsequent rotational position. In certain embodiments the system includes a rotary position sensor operably connected to the first rotatable element, where the rotary position sensor is configured to detect the rotational position of the first rotatable element. In various examples of the valve control system, the rotary position sensor comprises a resistive material having an electrical resistance when an electric current is applied, and the resistive material comprises a first end and a second end. In certain examples, the first rotatable element comprises a contact wiper, or is integrally or operably connected to a contact wiper, and the contact wiper is configured to rotate with the first rotatable element and, in at least some of its rotational positions, contact the resistive material between the first end and the second end. In various embodiments, the rotary position sensor is configured to apply an electric current to the resistive material and measure the electrical resistance of a portion of the resistive material between an end of the resistive material and the contact wiper to detect the rotational position of the first rotatable element.

In certain examples, the valve control system further includes a motor configured to rotate the first rotatable element, at least one computer processor, and at least one non-transitory computer-readable medium having stored thereon computer executable instructions. In certain embodiments, when the instructions are executed by the at least one processor, they cause the valve control system to rotate the first rotatable element from the initial rotational position to the at least one subsequent rotational position, where the rotary position sensor determines when the first rotatable element is in the at least one subsequent rotational position. In various examples, the instructions further cause the valve control system to rotate the first rotatable element from the initial rotational position to at least two subsequent rotational positions, where the rotary position sensor determines when the first rotatable element is in each of the at least two subsequent rotational position. In some example of the valve control system, the system is configured to rotate the first rotatable element directly from one subsequent rotational position to another subsequent rotational position.

In accordance with yet another exemplary aspect, methods are provided. In some examples, the method includes rotating a first rotatable element operably connected to a first moveable element of a valve assembly from an initial rotational position to at least four subsequent rotational positions, and moving, via the rotation of the rotatable elements and the operable connection to the moveable element, the first moveable element from an initial position, corresponding to the initial rotational position of the first rotatable element, to at least four subsequent positions corresponding to the at least four subsequent rotational positions of the first rotatable element. In some examples the method includes detecting the rotational position of the first rotatable element through a rotary position sensor operably connected to the first rotatable element. In various embodiments, the first rotatable element rotates directly from one subsequent rotational position to another subsequent rotational position.

In some examples, a motor rotates the first rotatable element, and at least one computer processor executes computer executable instructions stored on at least one non-transitory computer-readable medium to cause the motor to rotate the first rotatable element from the initial rotational position to one of the subsequent rotational positions, and to further cause the rotary position sensor to determine when the first rotatable element is in one of the subsequent rotational positions.

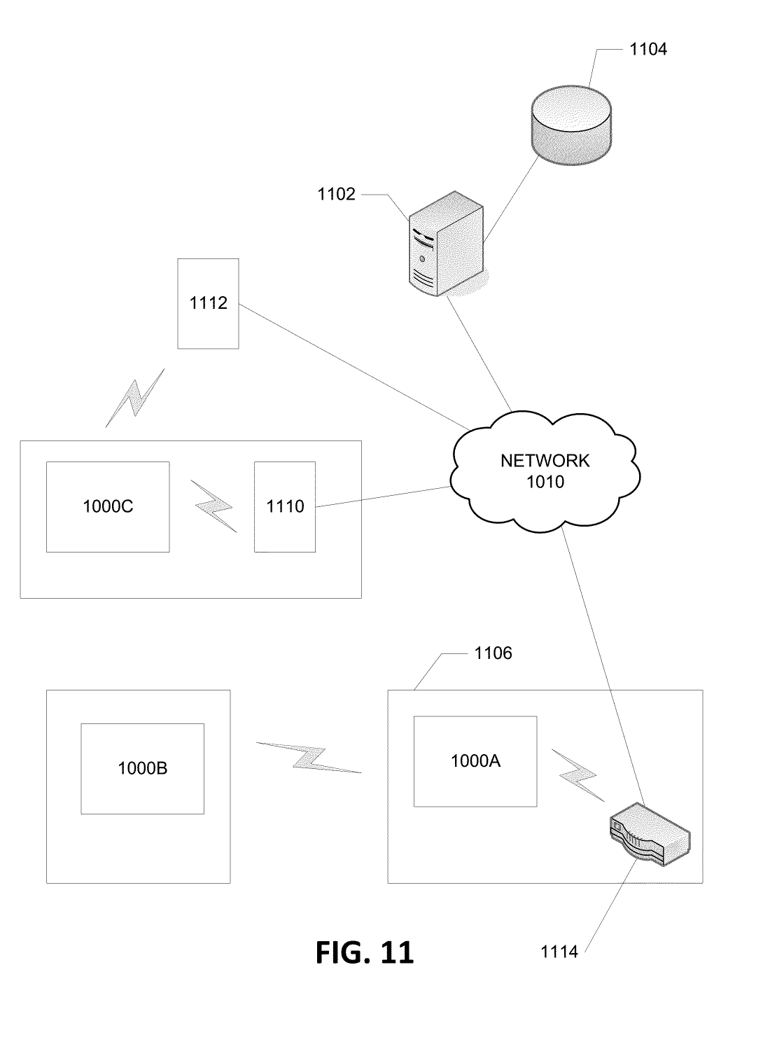

As mentioned above, FIG. 6 and FIG. 7 show illustrative embodiments of some water treatments systems. These water treatment systems are enhanced, as illustrated in FIG. 10, to include at least one computer processor 1001 and at least one non-transitory computer-readable medium having stored therein computer executable instructions, that when executed by the at least one processor, cause the water treatment system 1000 to perform various functions. Aspects of the steps described herein may be executed using one or more computer processors. Such processors 1001 may execute computer-executable instructions stored on non-transitory computer-readable media. For example, the water treatment system 1000 may comprise aspects of a computing device for controlling the overall operation of the system and its associated components. The device may include a computer processor 1001, one or more non-transitory computer-readable media (e.g., RAM 1003, ROM 1002, hard drive 1005, removable media 1004), one or more input/output modules, communication components (e.g., wireless communication component 1009 or wired communication components), a location determination component 1012, one or more measurement components 1011, and controller 1007. Any suitable computer readable media may be utilized, including various types of tangible and/or non-transitory computer readable storage media such as, Flash memory/EEPROM, hard disks, and the like. The one or more media may store computer-readable instructions (e.g., software) and/or computer-readable data (i.e., information that may or may not be executable), which may provide instructions to the processor for enabling the system to perform various functions.

The water treatment system 1000 may be further embodied in a networked environment such that the water treatment system 1000 may communicate through a communication component (e.g., wireless communication component 1009 or a wired communication component) over a network 1010 to other components and/or systems. For example, the water treatment system 1000 may communicate information and other data to devices 1102 external to the water treatment system, such as, but not limited to other water treatment systems, web/application server, a user's mobile computing device, wireless (e.g., IEEE 802.11) router, home appliances such as a washing/dryer, refrigerator, oven, or other devices.

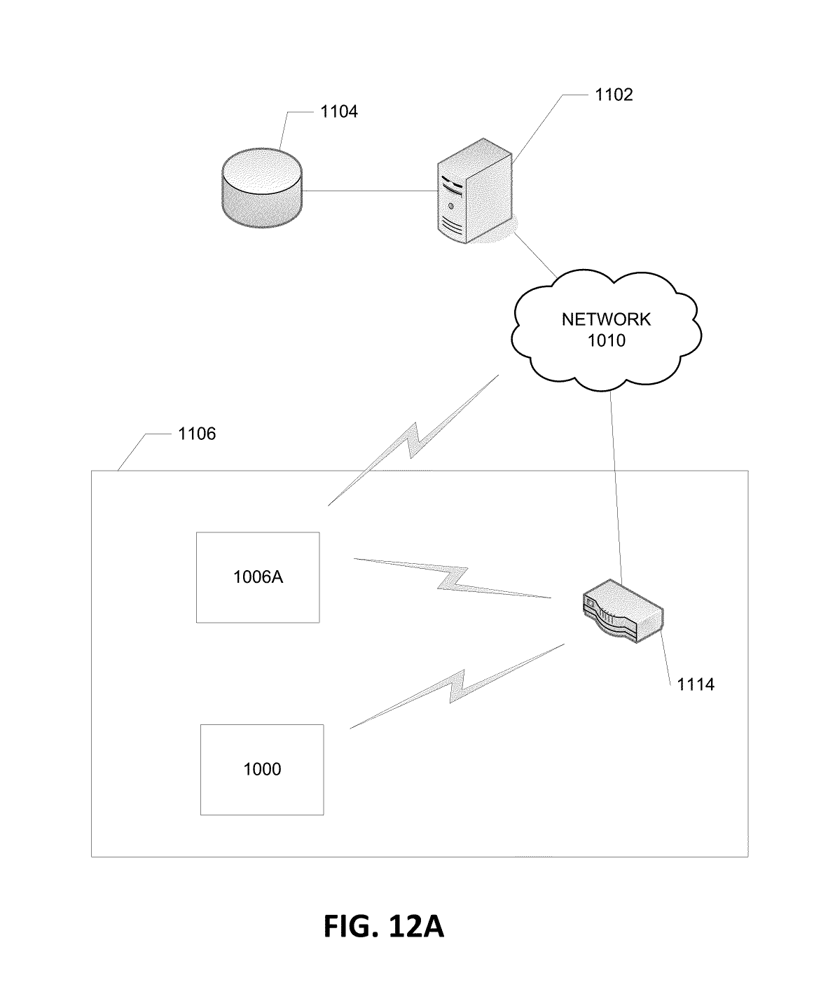

FIG. 11 illustrates various examples of communication between a water treatment system 1000 and a remote application server 1102. In one example, the water treatment system 1000A may be located at a residential premise (e.g., a single family house 1106) and communicate via a wireless router 1114 installed on the residential premise. The water treatment system 1000A may communicate using wireless communication component 1009 with the wireless router 1114, which sends/receives information via network 1010 to/from the remote application server 1102. Although depicted as a single box in FIG. 11, the application server 1102 may comprise a farm of servers or computing machines (e.g., data store 1104) that receive, store, process, and send the appropriate data.

In another example involving a “daisy-chain” approach, a water treatment system 1000B may communicate in a secure (e.g., encrypted) manner with another water treatment system 1000A (or in some instances, more than one water treatment system in a daisy-chain) to use the other water treatment system's capability to communicate with a remote application server 1102. Such a scenario may occur when a wireless router or other device typically relied upon by a water treatment system 1000B is offline or inoperative. As a result, the water treatment system 1000B may pursue alternate paths for communicating with the remote application server 1102.

In yet another example illustrated in FIG. 11, a water treatment system 1000C may use a “piggyback” approach in which the water treatment system 1000C may use a wireless communication component 1009 to communicate with an external device (e.g., a networked appliance 1110) to piggyback off the external device's networking capabilities to communicate with a remote application server 1102. Such a scenario may occur when a residential premises might not have Internet connectivity, but might still have devices that communicate using some other means (e.g., through a cellular modem, WiMax, etc.) over a network 1010. Similar to the preceding example, the water treatment system 1000C may piggyback off a trusted networked device 1112 outside of the premises (e.g., a shared wireless router amongst a community, an accessible neighboring networked appliance, etc.) to communicate with a remote application server 1102. In either scenario, the water treatment system 1000C would establish a secure (e.g., encrypted) means via which to electronically handshake with the external device and securely tunnel information between it and the remote application server 1102.

In addition to communicating with a remote application server 1102, in some examples, a water treatment system 1000 may communicate over network 1010 with a third-party server 1108. The third-party server 1108 may provide information/services such as, but not limited to, geocoding services (e.g., converting an inputted GPS coordinate into a zipcode or physical address), electricity rate tables, water rate tables, weather information, water hardness tables by zipcode or region, municipality information, or other information. This information may be used at either the water treatment system 1000 and/or at the application server 1102 to determine the operation of the water treatment system 1000 and/or generation of notifications. Although the foregoing examples describes communication between the water treatment system 1000 and the third-party servers 1108, alternatively, the information from the third-party server 1108 may be routed through the application server 1102 and data store 1104 such that third-party server 1108 passes the desired information to the application server 1102, which then processes, analyzes, and sends it to the water treatment system 1000, as appropriate. Although both network architecture designs are contemplated, at least one benefit of the later approach is that the application server 1102 may pre-process and/or package the information before communicating it to the numerous water treatment systems 1000A, 1000B, 1000C.

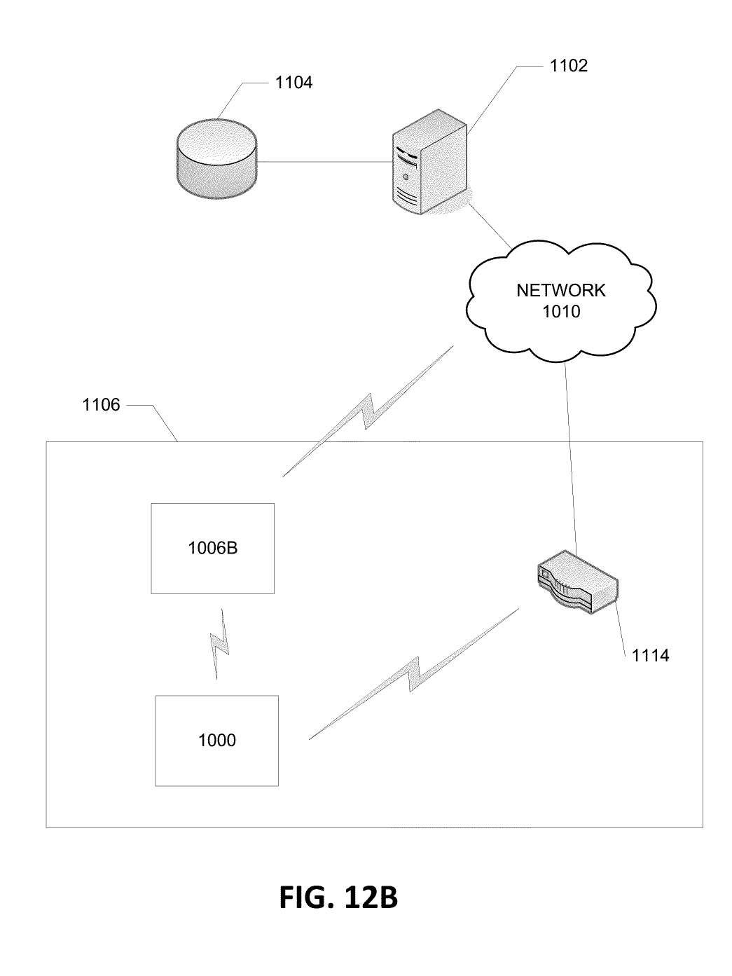

FIG. 12A and FIG. 12B illustrate a network diagram of an illustrative water treatment system 1000 in operational/normal mode and direct/repair mode, respectively. Although just two modes are illustrated, the disclosure is not so limited and contemplates systems with additional, fewer, or similar modes. In addition, the transition between modes may be manually initiated or may be automatic. For example, under one example of a manual approach, a button (e.g., a physical, mechanical button on a water treatment system 1000, or an electronic button on a touchscreen display on the water treatment system 1000) may be provided to activate the direct/repair mode. As a result, the wireless communication component 1009 in the water treatment system 1000 may go into, for example, a WiFi Direct mode. Thus, a user computing device 1006B may connect directly with the water treatment system 1000. Alternatively, a new water treatment system 1000 may arrive at a customer's premises 1106 with a factory-set direct/repair mode. Then, once the setup/installation is completed, the user computing device 1006B may request the processor 1001 to change the wireless communication component 1009 to another mode, such as, the operational/normal mode. In another example, the wireless communication component 1009 may be configured to await a request to directly connect (e.g., as in direct/repair mode), and upon receiving a request to connect in direct/repair mode, temporarily switching to the requested mode; then, once the connection is terminated, returning to the previous mode. In any event, the disclosure is not so limited to the various mode switching means described above, and the disclosure contemplates numerous other systems and methods to switch between modes of operation.

FIG. 12A illustrates a network diagram of an illustrative water treatment system 1000 in operational/normal mode. During normal operation, the water treatment system 1000 has already been installed and established communication with a device (e.g., wireless router 1114) that permits it access to a remote server 1102 via network 1010. Any handshake procedure or username/password required to connect with the device 1114 has already taken place and communication (e.g., wireless communication) has been established. Furthermore, if appropriate, any calibration or setup required of the water treatment system, including, but not limited to its location determination component 1012 and any measurement components 1011, will have already been performed earlier. During normal operation, the water treatment system 1000 may receive information from a location determination component 1012 and one or more measurement components 1011, then analyze/process that information before sending it to a remote server 1102 for any further analysis, storage, filtering, and/or alert generation.

A user of computing device 1006A (e.g., a homeowner's smartphone, a tablet computer, a PDA, or other mobile or non-mobile computing device) may receive information about the water treatment system 1000 from the remote server 1102. The computing device 1006A may have software installed on it (e.g., a smartphone application installed from an app store) to allow it to communicate with the server 1102. Alternatively, the computing device 1006A may use a web browser or other graphical user interface to communicate with the server 1102 (e.g., server 1102 comprising a farm of servers including a web server configured to communicate over the HTTP protocol.) In the example where the computing device 1006A is a smartphone, the computing device 1006A may communicate via its cellular modem with a network 1010 to gain access to the remote server 1102, or alternatively, the computing device 1006A may communicate via device 1114. In any event, during operational/normal mode, the wireless communication component 1009 in the water treatment system 1000 is configured to communicate with the remote server 1102 and not directly with the user computing device 1006A. As a result, any information/commands sent and/or received by the user computing device 1006A during normal operational mode are from the remote application server 1102 and not from the water treatment system 1000.

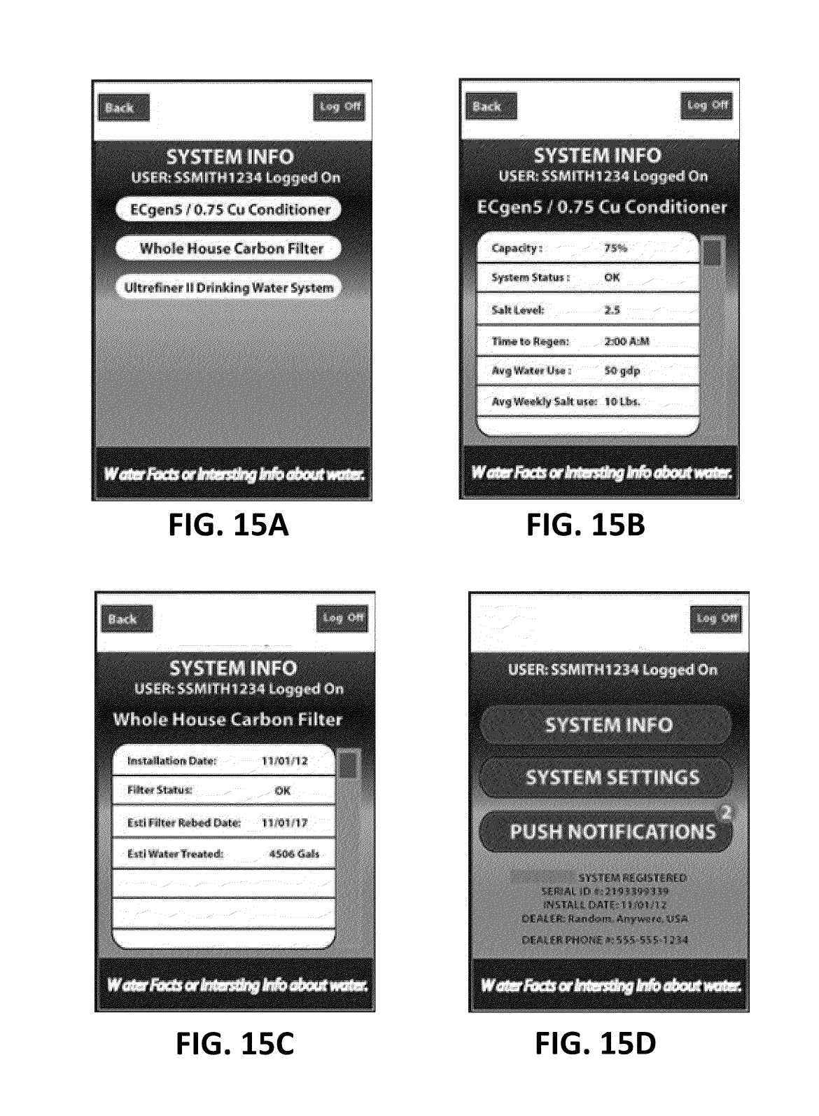

During operational/normal mode, the user computing device 1006A may communicate with the remote server 1102 to receive information about the water treatment system 1000. For example, the server 1102 (or a data store 1104 accessible through the server 1102) may store, inter alia, information provided by the water treatment system 1000, including current information and historical information. The user computing device 1006A may access the server to request and obtain, for example: customer settings, notification of any new alarms, notification of any unusual water use patterns, and other information that may be useful to a user. The user computing device 1006A may receive and display the aforementioned information on a display 1006 for the user to view/hear/perceive, such as the illustrative graphical user interfaces (GUIs) of FIG. 15A, FIG. 15B, FIG. 15C, and FIG. 15D. Furthermore, the user computing device 1006A may send updated information to the remote server 1102 for the server 1102 to use to update the local settings stored in memory (e.g., hard drive 1005) on the water treatment system 1000. As such, the remote server 1102 provides an interface through which the user computing device 1006A may view the operation of and update the operation of the water treatment system 1000.

Meanwhile, as illustrated in FIG. 12B, when the water treatment system 1000 is in direct/service mode, the water treatment system 1000 may communicate directly with a user computing device 1006B in the vicinity of the water treatment system 1000. The water treatment system 1000 may be delivered to a customer in direct/service mode (e.g., factory default setting) and may be useful when the water treatment system 1000 is initially being installed on the premises 1106B (e.g., in the home of the purchaser of the system 1000). The user computing device 1006B may perform handshake protocols with the water treatment system and establish communication with the wireless communication component 1009 of the water treatment system 1000. The disclosure contemplates handshake protocol methods including, but not limited to, those used by short-range wireless communication devices, Bluetooth™ devices, WiFi Direct (e.g., Roku3™ WiFi Direct, WiFi peer-to-peer), ad-hoc WiFi, Google™ Chromecast™ Internet of things (IoT) devices, and connected home devices. With direct communication established, the user computing device 1006B may update the settings/preferences associated with the water treatment system 1000.

As a result, the user computing device 1006B may configure the system 1000 to automatically connect to the known, trusted network (e.g., wireless network created by device 1114) in the future. In some examples, a username and/or password may be required to connect to the network created by device 1114. In a scenario where a professional install person is operating user computing device 1106B, the installer may relinquish control of the device 1106B to permit the owner/manager of the premises (or a person otherwise responsible for device 1114) to enter a username and/or password (or, for example, select a network name from a dropdown box) into a graphical user interface (GUI) on the user computing device 1106B to establish communication. As such, access to the homeowner's wireless network remains a secret and secure from the installer. In other words, the user computing device 1106B belonging to the installer is not connected to the homeowner's wireless network, but the device 1106B is still permitted to perform diagnostics of and other operations on the water treatment system 1000.

With communication established between the water treatment system 1000 and the device 1114 providing the wireless network, the water treatment system 1000 may proceed to send and receive information, commands, and/or other data with the remote server 1102. For example, the water treatment system 1000 may store computer executable instructions that, when executed by the at least one processor, cause the water treatment system 1000 to perform various methods. The water treatment system 1000 may be configured to respond to commands sent to it from the remote server 1102 and/or, during repair/direct mode, from a user computing device 1006B. A non-exhaustive list of commands that may be received and processed by the system 1000 include, but are not limited to commands to: change the time or date; change the salt level; turn off or postpone an alarm; reset an auxiliary alarm; turn vacation mode on/off; change installer settings; send a command to turn on an auxiliary output such as a shutoff value to turn off the main water supply; and/or other commands contemplated by a person having ordinary skill in the art after review of the entirety disclosed herein.

Moreover, the water treatment system 1000 may be configured to send information to the remote server 1102 and/or, during repair/direct mode, to a user computing device 1006B, in response to various triggering events. Likewise, the water treatment system 1000 may be configured to perform various acts in response to various triggering events. A non-exhaustive list of some triggering events and the resulting actions taken by the water treatment system 1000 and/or information sent by the water treatment system 1000 are listed below:
If the clock/timer indicates the defined data upload time, then the processor 1001 sends information stored in memory (e.g., hard drive 1005, RAM 1003, etc.) at the water treatment system 1000 to the remote server 1102 and/or (during repair/direct mode) a user computing device 1006B. The information may include, but is not limited to, alarm history information for the salt alarm, motor alarm, power loss alarm, filter alarm, drinking water alarm, air treatment alarm, and any other alarms or components capable of generating a notification/alert. Other examples of information that may be sent include repair history, such as event codes entered at the time of a service call. Other examples of information that may be sent include the current setting at the water treatment system 1000 (e.g., preference for metric system or English, time of day, current day, current date, auto daylight savings time, model type, unit size, media type, hardness level, iron level, time of regeneration, start capacity, total capacity, water to start regeneration, salt level, salt alarm, salt type (e.g., Na or K), service phone, and whether accessory alarms are on/off (e.g., filter, drinking water, and air treatment). Other examples of information includes last regeneration information and total life water used by the system 1000. The water treatment system 1000 may store in memory a date/time and/or time interval at which it uploads stored values to a remote server 1102. The processor 1001 compares this stored value with the clock/timer (not shown in FIG. 10) to determine when to trigger this event.
If the salt alarm is triggered because the current amount (e.g., pounds) of salt in the water treatment system 1000 is below a defined threshold amount (as measured by a salt measurement component 1011 coupled to a brine tank of the water treatment system 1000), then store the date/time of the alarm in memory as salt alarm history information, and send a notification to the remote server 1102 for processing. In addition, in some examples, the processor 1001 may use regeneration history information, water use history information, and salt alarm history information to customize the notification accordingly.
If the motor/position alarm is triggered because the measurement components 1011 detects a failure/defect in the motor or rotary position sensor in the water treatment system 1000, then store the date/time of the alarm in memory as motor/position alarm history information, and send a notification to the remote server 1102 for processing.
If the filter alarm is triggered because the measurement components 1011 detects unacceptable contaminants in the water outputted through the filter (not shown in FIG. 10) and out of the water treatment system 1000, then store the date/time of the alarm in memory as filter alarm history information, and send a notification to the remote server 1102 for processing. In another example, the measurement components 1011 associated with the filter alarm may measure the elapsed amount of time (e.g., calendar days set in months) and/or volume of liquid that has flowed through the system 1000. A clock device may be used to monitor the elapsed time and trigger an alarm when appropriate.
If the drinking water alarm is triggered because the measurement components 1011 detects unacceptable contaminants (e.g., bacteria, micro-organisms, etc.) in the water of the water treatment system 1000, then store the date/time of the alarm in memory as drinking water alarm history information, and send a notification to the remote server 1102 for processing.
If the air treatment alarm is triggered in the water treatment system 1000, then store the date/time of the alarm in memory as air treatment alarm history information, and send a notification to the remote server 1102 for processing.

When the triggering event occurs, the water treatment system 1000 will take the appropriate action. As a result, information is transmitted to the remote server 1102 and stored at the remote server 1102. That data is aggregated, filtered, analyzed, and stored. For example, particular information may be associated with the particular water treatment system 1000 from which it was reported and then sent to users for viewing. For example, the server 1102 (or a data store 1104 accessible through the server 1102) may store, inter alia, information provided by the water treatment system 1000, including current information and historical information. The user computing device 1006A can access the server to obtain and display, for example: customer settings, notification of any new alarms, notification of any unusual water use patterns, and other information that may be useful to a user.

During direct/repair mode, the user computing device 1006B may communicate with the remote server 1102 to receive information about the water treatment system 1000. In some examples, the user computing device 1006B may receive that information directly from the water treatment system 1000. For example, when the system 1000 is first being installed and it hasn't connected to a local, trusted network yet, the water treatment system 1000 might not be able to upload information to the remote server 1102 yet. Rather, the water treatment system 1000 may store collected/measured information in memory (e.g., RAM 1003, removable media 1004) on the water treatment system 1000, and send it, through its direct connection, to the user computing device 1006B for display/analysis. The user of operating user computing device 1006B may view the information and perform diagnostics accordingly, including, but not limited to, sending commands to the water treatment system 1000 for execution by the processor 1001 of the system 1000. Some examples of information displayed and/or commands requested including, but are not limited to, displaying customer settings, displaying installer settings, displaying history of changes to installer settings, displaying alarm history information, displaying notification of any new alarms, displaying repair history information, displaying notification of any unusual water use patterns, and other information that may be useful to an installer or repairperson.

In one example, the water treatment system may include a location determination component comprising global positioning satellite (GPS) circuitry (or other location triangulation circuitry) to detect the location/position of the water treatment system. The location of the water treatment system may correspond to its longitudinal/latitudinal coordinates, its closest physical address, zipcode (e.g., reversed geocoded zipcode corresponding to the determined GPS coordinates), or other location information. The processor 1001 may store the determined location in memory (e.g., RAM 1003) at the water treatment system 1000.

In another example, the location determination component might omit GPS circuitry and instead comprise stored instructions to determine the approximate location of the water treatment system 1000 using the Internet protocol (IP) address provided to the wireless communication component 10009 of the water treatment system. In some instances, the location determination component might transmit the IP address to a remote server to be reverse geocoded, and then corresponded to an approximate geographic location (e.g., zipcode, city/state, or other location information). If the IP address of the wireless communication component 1009 changes, the location determination component may send the new IP address to the remote server for reverse geocoding. If the new determined approximate location overlaps with the previous determined approximate location, the location may be determined to be the same. For example, the user (e.g., homeowner) of the water treatment system may have changed Internet server providers, thus explaining the change in the IP address. In other examples, the user might have moved the water treatment system to a new city, thus the changed IP address may be the direct result of actual movement of the water treatment system. In yet other examples, the IP address itself may serve as a location of the water treatment system, and subsequent changes to the IP address may be used to determine if the water treatment system has moved locations (e.g., if the leftmost tuples of the IP address change, this may signify a change in the location of the system, while a change in the rightmost tuple might be disregarded, in some examples).

In some examples, the location determination component may comprise an accelerometer (e.g., a three-axis accelerometer), gyroscope, and/or an electronic compass (in addition to, or in lieu of GPS circuitry and/or other stored instructions in the location determination component) to assist in detecting movement of the water treatment system. In such examples, if the water treatment system is caused to be moved or re-oriented (e.g., tipped over), the location determination component may detect and/or record such movement. In the example of a multi-story building, the location determination component may further include a barometer and/or altimeter to assist in measuring the height of the water treatment system. For example, in a multi-family building where each unit owner may possess his/her own water treatment system (or in a commercial environment where an industrial factory may comprise multiple systems), the location determination component may be capable of assisting in determining which floor of the building the system is located, hence which unit number (or factory group) corresponds to the system 1000.

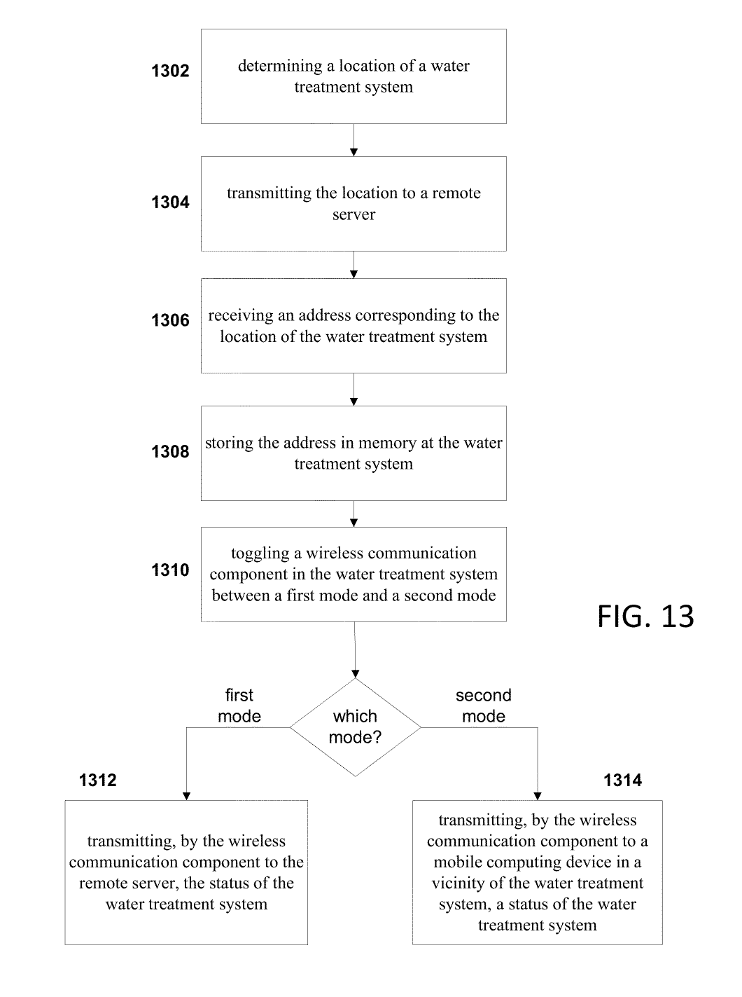

FIG. 13 shows a flowchart with some illustrative steps performed by a water treatment system in accordance with various aspects of the disclosure. In step 1302, the location determination component 1012 may determine a location of the water treatment system 1000. The location may be transmitted, in step 1304, to a remote server 1102. At the remote server 1102, the server may contact one or more external servers (e.g., geocoding servers) to obtain an address (e.g., a zipcode, state, region) corresponding to the location (e.g., GPS coordinates). In step 1306, the water treatment system may receive the address and store, in step 1308, the address in the memory at the water treatment system 1000. In some examples, the water treatment system may not store the address at the memory of the system 1000, but may use a unique identifier when later sending data to the remote server 1102 so that the data may be properly associated with the correct address/location.

In step 1310, the water treatment system may be toggled between a first mode (e.g., operational/normal mode) and a second mode (e.g., direct/repair mode). When in the first mode, the wireless communication component may connect with and transmit to the remote server 1102 the status of the water treatment system. Meanwhile in the second mode, the wireless communication component may connect with and transmit to a user computing device 1006B in the vicinity of the water treatment system, a status of the water treatment system. The second mode may be provide a professional repairman an opportunity to view status information and diagnostics of the water treatment system while visiting the homeowner's premises.

In some examples, the water treatment system may include one or more measurement components 1011 to measure characteristics of the water in the water treatment system and/or other aspects of the water treatment system or connected systems (e.g., the on-premises plumbing, the main plumbing supply line, etc.). Such a water treatment system 1000 may or may not include a location determination component. Examples of measurement components include, but are not limited to, at least one flow measurement component, at least one temperature measurement component, at least one pH measurement component, at least one composition measurement component, a combination of the foregoing, and/or other measurement sensors (e.g., sensor to measure pressure, sensor to measure conductivity, and other sensors).

In one example, one or more flow measurement components may be positioned to measure the flow of water through the water supply interface. In another example, one or more flow measurement components may be positioned to measure the flow of water through the plumbing system interface (i.e., the hose connection that leads out of the water treatment system 1000 and into the home/factory for which the system 1000 supplies water). In yet another example, the flow measurement components may be placed elsewhere in the water treatment system 1000, a cross-section of which is illustrated in FIG. 6.

In another example, one or more temperature measurement components may be positioned in the water treatment system 1000 to measure the temperature of the water arriving through the water supply interface. In another example, one or more temperature measurement components may be positioned to measure the temperature of the water being sent out through the plumbing system interface (i.e., the hose connection that leads out of the water treatment system 1000 and into the home/factory for which the system 1000 supplies water). In yet another example, the temperature measurement components may be placed elsewhere in the water treatment system 1000, a cross-section of which is illustrated in FIG. 6.

In yet another example, one or more pH measurement components may be positioned in various positions throughout the water treatment system 1000 to measure the pH of the water. Likewise, a composition measurement component may be positioned in various positions throughout the water treatment system 1000 to detect the presence and amount of various materials. For example, the composition measurement component may include a sensor to detect the presence of iron in the water. In another example, the composition measurement component may include a sensor to detect the presence of other minerals in the water, such as calcium, fluoride, and others, for example, by measuring total dissolved solids via water conductivity. In yet another example, the composition measurement component may contain a filter to detect the presence of various bacteria and other micro-organisms in the water, some which may be harmless or harmful to drinking water. The composition measurement component may be positioned inline or may be positioned for sampling.

In some illustrative examples, the measurement components 1011 may include one of the foregoing measurement components, a combination of or more than one of the foregoing measurement components, or none of the foregoing measurement components (i.e., a location determination component 1012 with no measurement components 1011). The measured characteristics of the water (or the water treatment system, or the systems in communication with the water treatment system) may be stored in memory (e.g., hard drive 1005) at the water treatment system 1000. The wireless communication component 1009 of the water treatment system 1000 may transmit the aforementioned stored characteristics to a remote computing device 1006 or server 1102. The server 1102 may store the received data in a data store 1104 and perform analysis on the aggregated data.

Water treatment systems may be installed in a residential and/or industrial/commercial environment. In a residential environment, some water treatment systems may include a water softener system, a reverse osmosis (RO) system, a UV treatment system (e.g., UV filter), an ozone related system, and/or a chemical treatment system. Similarly, one or more of the aforementioned may be included in a commercial/industrial installation of a water treatment system. Furthermore, in an industrial environment, the water treatment system may include further components particular to the products and/or services being offered. For example, in a distillery (e.g., a whiskey distillery), the water treatment system may incorporate the treatment of additional liquids besides just water. In such a water treatment system, the temperature of the water (e.g., whiskey), as well as other characteristics of the liquid, may be monitored either continuously, on a regular interval, and/or upon request. Such a system may include further components, such as a temperature gauge (e.g., a thermometer), a pressure gauge, viscosity gauge, and/or other measurement components, that interact within the water treatment system to monitor the characteristics of the liquid (e.g., alcohol) flowing through the water treatment system. This disclosure contemplates a water treatment system to include any system that involves the monitoring and/or treatment of any liquid (e.g., water, whiskey, alcohol, carbonated beverages, blood, petroleum, oil, and other liquids, as appropriate).

In one illustrative scenario, the location determination component 1012 may detect if aspects of the water treatment system 1000 are inoperative due to seismic activity (e.g., earthquake, sinkhole formation, explosion, or other acts causing movement of the ground) or catastrophic disaster (e.g., tornado, hurricane, tsunami, terrorist attack, or other acts). For example, assuming the seismic activity or catastrophic disaster resulted in noticeable movement of the ground upon which the water treatment system 1000 is installed, then a brine tank, resin tank, or other parts of an illustrative water treatment system 1000 may have tipped over or become otherwise inoperative. An accelerometer, gyroscope, and/or other sensors in the location determination component 1012 may detect the movement of the water treatment system 1000 and record the measurements in memory (e.g., RAM 1003) as status information. As such, the water treatment system 1000 may transmit an alarm notification to a remote server 1102 indicating accordingly, and enclosing one or more of the measurements. In some examples, one or more accelerometers may be positioned on various spots on the brine tank, resin tank, and other parts of the illustrative water treatment system to assist in detecting whether parts of the unit have re-oriented or tipped over, and as a safety measure, may shutoff the water treatment system 1000 if such detection occurs. Before the system is shutdown, the remote server 1102 may receive the notification and generate a notification (e.g., a push notification) to the user computing device 1006. Alternatively, the system 1000 may include a battery backup unit and/or a cellular modem (or other secondary wireless communication component) to permit the system 1000 to operate in the event of a power failure and/or home router 1114 failure.

In another example, the remote server 1102 may perform additional pre-processing before generating a notification to the user computing device 1006. For example, using the location determination component 1012, the remote server 1102 may determine the geographic location of the water treatment system 1000A that generated the notification. Then, the remote server 1102 may search a predetermined radius (e.g., 800 km, 400 km, 2 miles, or other distance) around that location to identify any other water treatment systems 1000B, 1000C within that vicinity. The remote server 1102 may search in the data store 1104 to search for any previously recorded location coordinates that fall within the predetermined area. In the event of an earthquake, other water treatment system's location determination components 1012 will have also measured movement resulting from the seismic activity. If these other water treatment systems also measured movement, then the remote server 1102 may conclude that the movement was not specific to the one system 1000A; rather, it was pervasive across all systems 1000B, 1000C within proximity to the earthquake or other seismic activity. As a result, using the benefits of aggregated data stored in the data store 1104, the remote server 1102 may enhance the notification reported to the user computing device 1006, for example, to include that others in the area also experience the same/similar movement/re-orientation/toppling over of their water treatment systems.

Furthermore, the server 1102 may send a notification to professional repair personnel and/or water treatment system specialists in the geographic area. The notification, in some examples, might just include the general area affected. In other examples, the notification may include specific addresses (or geo locations) affected, the make/model/year of the water treatment system at that location, and other information (e.g., customer name, phone number, etc.). These repairmen may then proactively contact owners of the water treatment systems to provide repair/maintenance/inspection services.

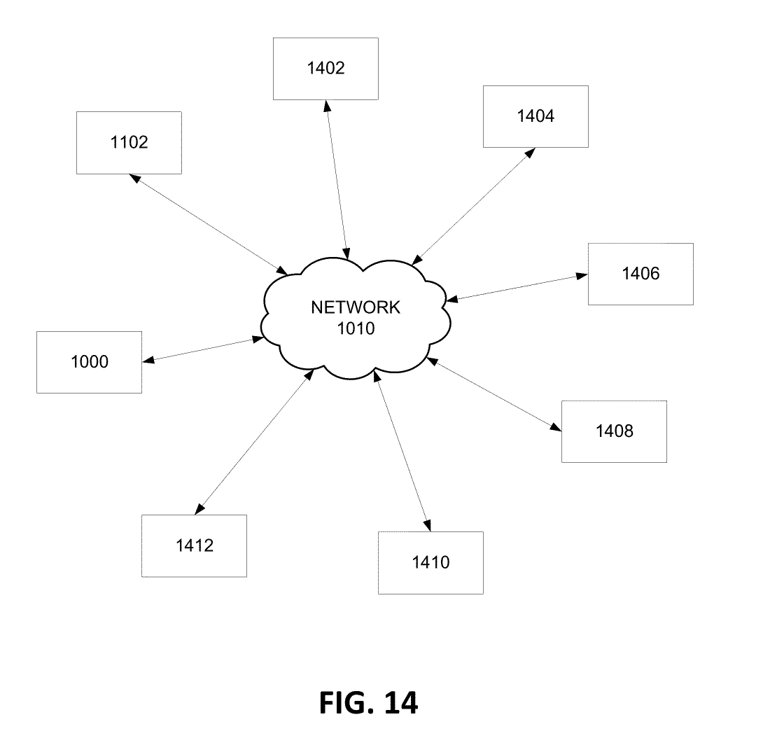

In another illustrative scenario, the location determination component 1012 may detect the location of the water treatment system 1000 and provide the location to a remote server 1102. The remote server may contact one or more third-party/external servers to associate the location with further information. As illustrated in FIG. 14, the remote server 1102 may contact a weather server 1402, geocoding/reverse-geocoding server 1404, electricity rates server 1406, water rates server 1408, repairshop 1410, and/or other servers/systems 1412 to obtain further information. For example, the server 1102 may send location information to an electricity rates server 1406 to obtain the electricity rates tables (i.e., the dollar per kilowatt charges for electricity in the particular area based on time of day and date) for the location where the water treatment system 1000 is installed. Using the electricity rates table, the remote server 1102 may sort the rates to identify the lower rates in the table. Then, the remote server 1102 may schedule high energy consuming activities of the water treatment system 1000 to occur during those lower-rate times. The server 1102 may transmit those lower-rate time settings to the water treatment system 1000 so that the system 1000 may be configured to operate accordingly.

Similarly, other information may be provided by other illustrative servers, including those illustrated in FIG. 14. For example, similar to the electricity rates server 1406, a water rates server 1408 may provide similar water rates for particular geographic locations. Water rates may be significant in areas such as California where severe droughts may cause municipalities to restrict the times of day when lawns may be watered, etc. As such, water treatment systems 1000 can fall in-line with municipalities requirements and/or recommendations. In addition, a weather server 1402 may assist in providing information about catastrophic weather or other phenomenon occurring in the geographic area of the water treatment system 1000. The remote server 1102 may receive information from the weather server 1402, pre-process the information to identify pertinent data, then compare the measured data it received from the water treatment system 1000 to identify any anomalies or irregular patterns in the measured data that might be related to the weather data. As such, the server 1102 may be in a position to provide enhanced reporting and counseling to users (e.g., owners, repairmen, etc.) of water treatment systems 1000.

In yet another illustrative scenario, the water treatment system 1000 may use one or more measurement components 1011 of the water treatment system 1000 to provide an early detection of upcoming issues with the system or surrounding environment. For example, a measurement component 1011 at the water supply interface (e.g., the hose through which untreated water is provided to the system 1000) may measure the rate of flow of water through the interface. In one example, a flow measurement component may be used to measure the rate of flow of liquid passing through the interface. The measurements may be stored and aggregated at a remote server 1102. Over time, an analysis of the flow measurements may provide an early detection of issues in the plumbing outside the premises 1106. For example, in extremely cold weather, the pipes leading into a home may begin to freeze if appropriate precautions were not taken. As the pipe begins the freeze, the flow rate through the pipe may begin to decrease before it eventually stops completely. If identified early, the freezing may be preemptively addressed and avoided. Comparing the current readings of the flow measurement component with earlier readings, a consistent reduction in the flow rate may cause a notification to be generated. The notification may be generated by a remote server 1102 and go to a user computing device 1006 and/or a computing device of municipality personnel, such as a streets and water department of a city.

In some examples, the early detection of frozen pipes may incorporate readings from a temperature measurement component of the measurement components 1011. The temperature measurement component may be positioned at the water supply interface (e.g., the hose through which untreated water is provided to the system 1000) so that the temperature of incoming, untreated water may be measured. As the main pipeline freezes, the temperature of the incoming water may substantially drop as well. Comparing the current readings of the temperature measurement component with earlier readings may trigger a notification that the pipeline is beginning to freeze. In another example, the temperature measurement component and flow rate measurement component may work together to increase confidence in the generated alert. In yet another example, the system 1000 may use only the temperature measurement component and omit use of the flow measurement component. In any event, the generated alert may further include information such as the current reading as compared to earlier/historical readings.

In yet another scenario, the location determination component 1012 of the water treatment system 1000 may generate a notification to a repairshop/dealer of water treatment systems if the location of the system 1000 changes by more than a threshold distance (e.g., more than 100 meters). Such a change may indicate that the owner of a water treatment system 1000 has moved homes/factories and has transported the system 1000 to another home/factory at a different location. Unbeknownst to the new owner, the previous home/factory may be in need of a water treatment system 1000. A dealer of water treatment systems may visit or otherwise solicit the new homeowner, including providing collected information about the hardness of the water and other information collected over time. Furthermore, the recently-moved water treatment system 1000 may send a notification to the remote server 1102 with an indication of the new address of the system 1000. As such, an installation expert or other professional may contact the owner at the new address to provide assistance with installation and/or inspection. In an alternate example, a water treatment system 1000 may regularly communicate (e.g., at least daily, at least bi-weekly, at least monthly, or some other fixed or variable interval of time) with a remote server 1102 and in the absence of such communication, the remote server 1102 may generate a notification to one or more computing devices 1410, 1006 alerting user(s) that the water treatment system may require servicing or has been abandoned (e.g., a user has moved from the home and left the system 1000 behind). Accordingly, a dealer or other user may react to the notification to provide one or more services.

Furthermore, the location determination component 1012 provides enhanced opportunities for promoting the sale of water treatment systems. For example, if an area shares the same water source, the installation of a water treatment system 1000 at one home in a community may trigger a notification to a dealer to attempt sales of the system in the neighboring homes. The notification may include information about the collected hardness of the water and other information that a homeowner may find useful. Since the process is automated, a dealer (e.g., manufacturer) of water treatment systems need not be concerned with collecting name and address information from each customer. Rather, even if the purchase is done anonymously, the location determination component 1012 provides information to allow the dealer to identify the relevant neighborhood for further marketing opportunities.

The measured data collected for storage in a data store 1104 may be aggregated and analyzed to identify recommendations for distribution to one or more water treatment systems 1000. For example, data from a plurality of water treatment systems within the same vicinity may be aggregated at the remote server 1102 and analyzed to determine if changes/trends in the characteristics of the water are emerging. For example, if the hardness of water in an area has increased over time (e.g., over the period of one or more years), the delta change may be transmitted to the appropriate persons (e.g., homeowners in the vicinity, owners of affected water treatment systems, municipality water department, dealers of water treatment systems, or others).

Moreover, in some example, a recommendation engine at the remote server 1102 may formulate updated preferred configuration settings (e.g., settings that affect the operational behavior of the water treatment system 1000) and transmit them to the water treatment system 1000 for implementation. As such, the water treatment system 1000 may be configured with rules to automate changes in the operational functionality of the water treatment unit. In some examples, the processor 1001 in the water treatment system 1000 may receive instructions from the remote server 1102 that cause it to update configuration settings stored in its memory (e.g., RAM 1003) or cause particular acts to commence, such as causing measurement components 1011 or location determination components 1012 to take readings and transmit them via wireless communication component 1009 to a remote computing device.

In one example, collected measurement data from the system 1000 may be used to determine a change in flow statistics to notify a user of one or more potential issues. No daily flow measured for a plurality of days while the unit is not set to “vacation mode,” may mean a possible failure in the flow measurement component of the system 1000. An appropriate notification may be sent to one or more users. Moreover, if more than a threshold of flow is measured while the system is set to “vacation mode,” then this may mean a possible leak, either in the system 1000 or somewhere on the premises (e.g., in a user's home). In addition, a substantial increase in flow measurements compared to historical measurements (e.g., long term averages of historical measurements) may indicate a possible leak or failure of some appliance that involves water. In yet another example, a continuous flow measured over an extended period of time in one day may indicate a possible pipe burst or leak. In all of the above scenarios, an appropriate notification may be sent to one or more users. Furthermore, the system may coordinate with a networked, whole-house water shutoff valve that may be remotely triggered by the system 1000 or other device 1102 to shut off water if appropriate, e.g., if a significant pipe burst or leak is identified.

These method descriptions are merely exemplary. In certain embodiments, the method comprises additional combinations or substitutions of some or all of the steps described in this disclosure. Moreover, additional and alternative steps will be recognized by those skilled in the art given the benefit of this disclosure.

Although the terms “water softener system” and “water treatment system” have sometimes been interchanged in the foregoing description, the term “water treatment system” is not limited to just water softener systems and is intended to include any system that involves the treatment and/or processing of any one or more liquids. Likewise, FIG. 10 illustrates a computer processor 1001 and a separate controller 1007, however, the disclosure is not so limiting; in some embodiments, the functionality of a computer processor 1001 may be embodied within a controller 1007, and vice-versa. For example, an application-specific integrated circuit (ASIC) or other mechanism may be used to provide the functionality of one or more items displayed in FIG. 10 as a single component in the illustrative figure. In addition, although not illustrated in FIG. 10, an illustrative water treatment system 1000 contemplated herein may include an internal battery and/or external battery backup for purposes of being able to operate and communicate information (even if just temporarily during a power outage) to a remote server 1102.

We claim:

1. A water treatment system comprising:
a brine tank;
a resin tank;
a water supply interface;
a drain interface;
a plumbing system interface;
a valve assembly coupled to at least two of: the brine tank, the resin tank, the water supply interface, the drain interface, and the plumbing system interface;
a location determination component;
a wireless communication component;
a processor communicatively coupled to the wireless communication component and the location determination component; and
a non-transitory memory storing executable instructions that, when executed by the processor, causes the water treatment system to:
measure a status of the water treatment system, wherein the status of the water treatment system comprises a location of the water treatment system determined by the location determination component; and
transmit, by the wireless communication component to a remote server, the status of the water treatment system.

2. The water treatment system of claim 1, further comprising:
at least one flow measurement component;
at least one temperature measurement component;
at least one pH measurement component;
at least one composition measurement component; and
the processor further communicatively coupled to the flow measurement component, the temperature measurement component, the pH measurement component; and the composition measurement component;
wherein the non-transitory memory stores executable instructions that, when executed by the processor, further cause the water treatment system to:
measure a characteristic of water in the water treatment system; and
transmit, by the wireless communication component to the remote server, the characteristic of the water, wherein the characteristic of the water comprises:
a flow of the water through the water supply interface determined by the at least one flow measurement component,
a temperature of the water through the water supply interface determined by the at least one temperature measurement component,
a pH of the water through the water supply interface determined by the at least one pH measurement component, and
a composition of the water through the water supply interface determined by the at least one composition measurement component.

3. The water treatment system of claim 1, further comprising:
at least one measurement component; and
the processor further communicatively coupled to the at least one measurement component;
wherein the non-transitory memory stores executable instructions that, when executed by the processor, further cause the water treatment system to:
measure, by the at least one measurement component, a characteristic of water in the water treatment system; and
transmit, by the wireless communication component to the remote server, the characteristic of the water.

4. The water treatment system of claim 3, wherein the at least one measurement component comprises at least one flow measurement component arranged to measure a flow of the water through the water supply interface; and
wherein the non-transitory memory stores executable instructions that, when executed by the processor, further cause the water treatment system to:
receive, by the wireless communication component, a notification from the remote server, wherein the notification comprises an indication that a water main supply line providing the water through the water supply interface is becoming obstructed.

5. The water treatment system of claim 4, wherein the at least one measurement component further comprises at least one temperature measurement component arranged to measure a temperature of the water through the water supply interface; and
wherein the non-transitory memory stores executable instructions that, when executed by the processor, further cause the water treatment system to:
measure a temperature of the water through the water supply interface determined by the at least one temperature measurement component,
transmit, by the wireless communication component to the remote server, the measured temperature of the water and the measured flow of the water; and
receive, by the wireless communication component, a notification from the remote server, wherein the notification comprises an indication that a water main supply line providing the water through the water supply interface is becoming obstructed.

6. The water treatment system of claim 1, further comprising:
at least one flow measurement component positioned near the water supply interface;
at least one temperature measurement component positioned near the water supply interface; and
the processor further communicatively coupled to the flow measurement component and the temperature measurement component;
wherein the non-transitory memory stores executable instructions that, when executed by the processor, further cause the water treatment system to:
measure, by the at least one temperature measurement component, a temperature of the water flowing through the water supply interface;
measure, by the at least one flow measurement component, a flow of the water through the water supply interface;
transmit, by the wireless communication component to the remote server, the measured temperature of the water and the measured flow of the water; and
receive, by the wireless communication component, a notification from the remote server, wherein the notification comprises an indication that a water main supply line providing the water through the water supply interface is becoming obstructed.

7. The water treatment system of claim 3, wherein the non-transitory memory stores executable instructions that, when executed by the processor, further cause the water treatment system to:
receive, by the wireless communication component from the remote server, a command for execution by the processor of the water treatment system.

8. The water treatment system of claim 1, wherein the location determination component comprises at least one of: an accelerometer configured to detect movement of the water treatment system and a GPS circuitry.

9. The water treatment system of claim 1, wherein the location determination component comprises GPS circuitry to determine the location of the water treatment system, and wherein the non-transitory memory stores executable instructions that, when executed by the processor, further cause the water treatment system to:
store a zipcode corresponding to the location of the water treatment system, including sending the location to the remote server for determination of the zipcode corresponding to the location.

10. The water treatment system of claim 9, wherein the remote server is in communication over a network with at least one of: a geocoding server, a weather server, an electricity rates server, a water rates server, and a repairshop.

11. The water treatment system of claim 1, further comprising:
a button configured to toggle the wireless communication component from a first mode to a second mode; and
wherein the non-transitory memory stores executable instructions that, when executed by the processor, further cause the water treatment system to:
transmit, by the wireless communication component to a mobile computing device in a vicinity of the water treatment system, the status of the water treatment system when in the second mode; and
transmit, by the wireless communication component to the remote server, the status of the water treatment system when in the first mode.

12. The water treatment system of claim 11, wherein the first mode is an operational mode and the second mode is a repair mode.

13. A method comprising:
determining, by a location determination component in a water treatment system, a location of a water treatment system;
transmitting the location to a remote server;
receiving an address corresponding to the location of the water treatment system; and
storing the address in memory at the water treatment system.

14. The method of claim 13, wherein the remote server is configured to determine an address corresponding to the location using a reverse geocoding server, the method further comprising:
toggling a wireless communication component in the water treatment system between a first mode and a second mode;
when in the second mode, transmitting, by the wireless communication component to a mobile computing device in a vicinity of the water treatment system, a status of the water treatment system, wherein the status of the water treatment system comprises a location of the water treatment system; and
when in the first mode, transmitting, by the wireless communication component to the remote server, the status of the water treatment system.

15. The method of claim 13, further comprising:
measuring, by at least one flow measurement component, a flow of water through a water supply interface of the water treatment system;
measuring, by at least one temperature measurement component, a temperature of the water through the water supply interface of the water treatment system; and
transmitting, by a wireless communication component of the water treatment system to the remote server, the measured temperature of the water and the measured flow of the water;
wherein the remote server compares the measured temperature of the water and the measured flow of the water to historical measured values to generate a notification comprising an indication that a water supply line providing the water through the water supply interface is becoming frozen.

16. The method of claim 13, wherein the location determination component comprises at least one of: GPS circuitry and accelerometer.

17. The method of claim 13, further comprising:
measuring, by at least one flow measurement component, a flow of water through the water treatment system;
measuring, by at least one temperature measurement component, a temperature of the water through the water treatment system;
measuring, by at least one pH measurement component, a pH of the water through the water treatment system;
measuring, by at least one composition measurement component, a composition of the water through the water treatment system; and
transmitting, by a wireless communication component of the water treatment system, the measured temperature of the water, the measured flow of the water, the measured pH of the water, and the measured composition of the water.

18. A remote server system comprising:
a processor;
a communications component communicatively coupling the processor with a network;
the network communicatively coupling the processor with a water treatment system;
the network further communicatively coupling the processor with a mobile user computing device;
a data store; and
a non-transitory memory storing executable instructions that, when executed by the processor, further cause the remote server system to:
receive measured data from the water treatment system;
store the measured data in the data store;
compare the measured data with historical data in the data store; and
generate a notification to the mobile user computing device indicating at least one of: an obstruction in a supply line providing water to the water treatment system, movement of the water treatment system, and maintenance alerts.

19. The system of claim 18, wherein the non-transitory memory stores executable instructions that, when executed by the processor, further cause the remote server system to:
send a command to the water treatment system that causes the water treatment system to update settings.

20. The system of claim 18, wherein the mobile user computing device is a smartphone of a owner of the water treatment system.
